(19) United States
(12) Patent Application Publication
(10) Pub. No.: US 2026/0361830 A1
(43) Pub. Date: Nov. 12, 2026

(54) READING APPARATUS, READING METHOD, AND STORAGE MEDIUM

(71) Applicant: CANON KABUSHIKI KAISHA, Tokyo (JP)

(72) Inventors: Kazufumi KONDO, Kanagawa (JP); Shinjiro HORI, Kanagawa (JP); Yuki ISHIDA, Kanagawa (JP); Yoshinori MIZOGUCHI, Tokyo (JP); Yuto KAJIWARA, Kanagawa (JP); Naoki SUMI, Kanagawa (JP); Takayuki YAMADA, Kanagawa (JP); Kosuke SASAKI, Kanagawa (JP)

(21) Appl. No.: 19/561,710

(22) Filed: Mar. 10, 2026

(30) Foreign Application Priority Data
Mar. 13, 2025 (JP) 2025-040255

(51) Int. Cl. H04N 1/60; G06V 10/764

(52) U.S. Cl. CPC H04N 1/603; G06V 10/764

(57) ABSTRACT

The present disclosure is directed to appropriately correct an image. A reading apparatus includes: a reading unit configured to be capable of reading a document; a model execution unit configured to cause a machine learning model to execute a process using a read image of the document obtained based on reading by the reading unit as an input, the machine learning model having been trained for correction of a background of a document surface by using a shape of the document surface; and an obtaining unit configured to obtain a corrected image subjected to a pixel correction process using a result of the process executed by the model execution unit, the pixel correction process being a process of correcting a color of a pixel of a background portion in the read image of the document.

### BACKGROUND

### Field of the Technology

The present disclosure relates to a reading apparatus, a reading method, and storage medium.

### Description of the Related Art

As reading apparatuses, image scanners using an image sensor have been known. Also, documents' paper surfaces tend to be white. Here, a read image obtained by reading a document with such a reading apparatus may be such that the color of its background portion corresponding to the document's paper surface is not white (R, G, B=255, 255, 255). This is because the reading apparatus adjusts colors based on luminance information of a white plate and, in a case where the luminance of the print medium is low, the white color is not reproduced in the read image. To improve the quality of a read image, some reading apparatuses perform a process of correcting the colors of the pixels of the background portion in the image.

Japanese Patent Laid-Open No. 2016-220107 discloses a technique in which whether to convert the color of the background portion of an image is judged based on a histogram indicating the signal value of each pixel in the image as frequency in a predetermined density range.

### SUMMARY

Here, the shapes of document surfaces vary such that an image may not be appropriately corrected.

A reading apparatus according to an aspect of the present disclosure includes: a reading unit configured to be capable of reading a document; a model execution unit configured to cause a machine learning model to execute a process using a read image of the document obtained based on reading by the reading unit as an input, the machine learning model having been trained for correction of a background of a document surface by using a shape of the document surface; and an obtaining unit configured to obtain a corrected image subjected to a pixel correction process using a result of the process executed by the model execution unit, the pixel correction process being a process of correcting a color of a pixel of a background portion in the read image of the document.

Features of the present disclosure will become apparent from the following description of embodiments with reference to the attached drawings. The following description of embodiments are described by way of example.

### BRIEF DESCRIPTION OF THE DRAWINGS

FIG. 1 is a view illustrating an example of an exterior configuration of a reading apparatus;

FIG. 2 is a diagram illustrating an example of a configuration of a reading unit;

FIG. 3 is a block diagram illustrating an example of a configuration of the reading apparatus;

FIG. 4 is a flowchart illustrating an example of image processing to be executed by an image processing unit;

FIG. 5 is a diagram illustrating an example of a machine learning model;

FIG. 6 is a diagram for describing a convolution process;

FIG. 7 is a diagram illustrating an example of a learning setting screen;

FIG. 8 is a flowchart illustrating an example of a learning process;

FIG. 9 is a flowchart illustrating an example of a training data creation process;

FIGS. 10A to 10E are diagrams illustrating example images for describing training data;

FIG. 11 is a flowchart illustrating an example of a background correction process in a first embodiment;

FIG. 12 is a block diagram illustrating an example of a configuration of the reading apparatus in a case where it is a copying apparatus;

FIG. 13 is a diagram illustrating an example of a setting screen;

FIG. 14 is a flowchart illustrating an example of the background correction process using a rule base;

FIG. 15 is a diagram illustrating an example of a machine learning model as another image generation model;

FIG. 16 is a diagram illustrating an example of a machine learning model as a classification model;

FIG. 17 is a diagram illustrating an example of one-dimensional lookup tables (1D-LUTs);

FIG. 18 is a diagram illustrating an example of a training data creation screen in a second embodiment;

FIG. 19 is a flowchart illustrating an example of a training data creation process in the second embodiment;

FIG. 20 is a flowchart illustrating an example of a background correction process in the second embodiment;

FIG. 21 is a diagram illustrating an example of a machine learning model used in a third embodiment;

FIG. 22 is a diagram illustrating an example of a training data creation screen in the third embodiment;

FIG. 23 is a flowchart illustrating an example of a training data creation process in the third embodiment;

FIG. 24 is a diagram illustrating an example of a setting screen in the third embodiment;

FIG. 25 is a flowchart illustrating an example of a background correction process in the third embodiment;

FIG. 26 is a diagram illustrating an example of a training data creation screen in a case of using a classification model that classifies a threshold value; and

FIG. 27 is a diagram illustrating an example of a setting screen in another embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### <Image Reading Apparatus>

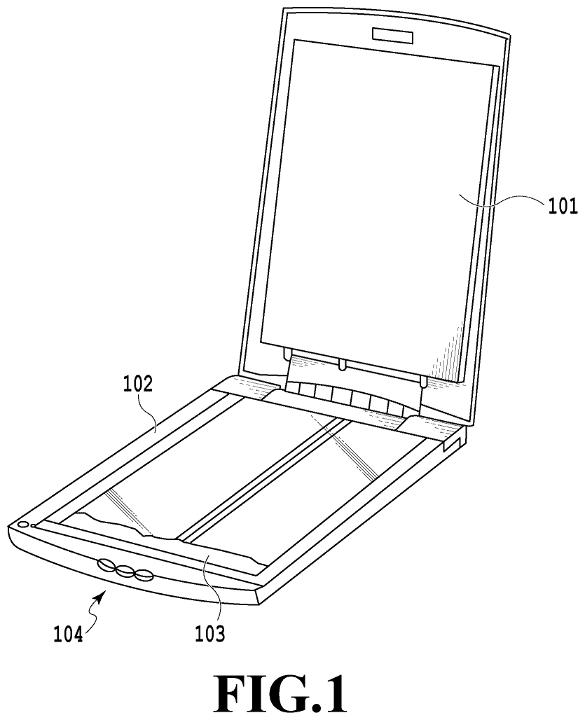

FIG. 1 is a view illustrating an example of an exterior configuration of a reading apparatus 100. The reading apparatus 100 includes a document plate cover 101, a document plate 102, a reading unit 103, and an operation part 104. The document plate cover 101 is a member that holds down a document placed on the document plate 102. The document plate 102 is a plate to place a document. The reading unit 103 is capable of reading the document placed on the document plate 102. The operation part 104 is an operation device operable by the user. In response to an operation by the user, the operation part 104 outputs information for executing an action corresponding to that operation.

In a case of reading a document with the reading apparatus 100, the user places the document on the document plate 102, holds down that document with the document plate cover 101, and then operates the operation part 104. The operation part 104 is provided with a plurality of buttons. Some of the plurality of buttons are a first read button, a second read button, and a third read button. The first read button is a button for executing a high-resolution color scan mode being a mode for performing color reading at a high resolution. The second read button is a button for executing a low-resolution color scan mode being a mode for performing color reading at a low resolution. The third read button is a button for executing a high-resolution monochrome scan mode being a mode for performing monochrome reading at a high resolution. The user presses a button corresponding to a scan mode which the user desires. In response to this press, the reading unit 103 starts reading the document.

In the high-resolution color scan mode, the reading apparatus 100 can read a document at a high resolution in color. In the low-resolution color scan mode, the reading apparatus 100 can read a document at a low resolution in color. In the high-resolution monochrome scan mode, the reading apparatus 100 can read a document at a high resolution in monochrome.

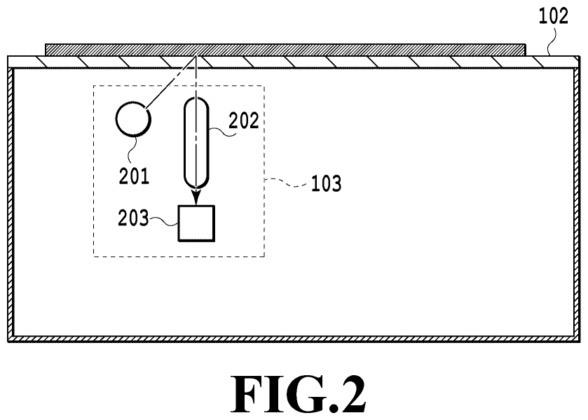

FIG. 2 is a diagram illustrating an example of a configuration of the reading unit 103. The reading unit 103 is movable in a main scanning direction and a sub scanning direction intersecting the main scanning direction. The reading unit 103 is moved by motors (not illustrated). The reading unit 103 includes a light source 201, a rod lens array 202, and a sensor 203. The reading unit 103 applies light from the light source 201 onto a document placed on the document plate 102, and light with a diffusely reflected component reflected by the document passes through the rod lens array 202. The sensor 203 detects the light having passed through the rod lens array 202 and performs photoelectrically converts the detected light. The sensor 203 outputs a signal obtained by the photoelectric conversion.

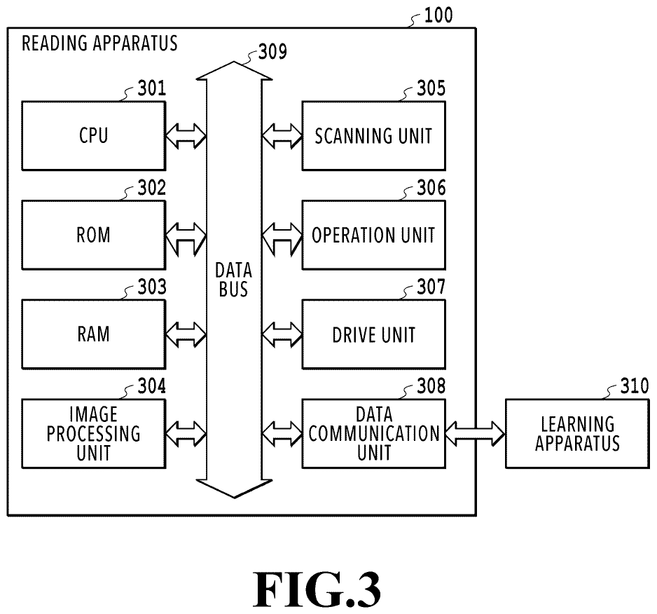

FIG. 3 is a block diagram illustrating an example of a configuration of the reading apparatus 100. The reading apparatus 100 includes a central processing unit (CPU) 301, a read-only memory (ROM) 302, a random-access memory (RAM) 303, an image processing unit 304, a scanning unit 305, an operation unit 306, a drive unit 307, a data communication unit 308, and a data bus 309.

The CPU 301 is a processing unit for implementing various functions of the reading apparatus 100. The CPU 301 includes at least one processor. The CPU 301 executes various processes by executing programs or activating hardware. The CPU 301 executes the programs by reading out the programs to the RAM 303 and expanding them.

The ROM 302 stores various pieces of data. For example, the ROM 302 stores programs to be executed by the CPU 301. Also, the ROM 302 stores various values, tables, mathematical equations, and the like to be used in image processing, such as shading correction. The various values to be used in the image processing include learned parameters. The learned parameters are model parameters obtained by learning. The model parameters are parameters to be used by machine learning models.

The RAM 303 is used as a work memory for the CPU 301 and the like. For example, the RAM 303 temporarily stores various pieces of information in a case where the CPU 301 executes programs or in a case where the image processing unit 304 performs image processing.

The image processing unit 304 performs image processing such as correction of image data generated by the scanning unit 305 or image encoding. The image data correction includes shading correction and gamma correction.

The scanning unit 305 obtains the signal output from the reading unit 103. This signal includes, for example, values indicating red (R), green (G), and blue (B) analog luminances. The scanning unit 305 executes an analog-to-digital (AD) conversion process on the obtained signal based on the scan mode designated by the user, and generates image data corresponding to the scan mode.

The operation unit 306 monitors each of the plurality of buttons included in the operation part 104 (FIG. 1). In response to detecting any of the plurality of buttons, the operation unit 306 outputs information corresponding to the detected button. For example, in response to detecting a press on any of the first read button, the second read button, and the third read button, the operation unit 306 outputs an instruction to perform reading in the scan mode corresponding to the detected button.

The drive unit 307 is a unit that causes the reading unit 103 to operate. The drive unit 307 includes, for example, a driver circuit and the like for controlling the motors that drive the reading unit 103.

The data communication unit 308 is an interface that receives and outputs data from and to one or more external devices. One of the external devices is a learning apparatus 310. The learning apparatus 310 is an apparatus that causes a machine learning model to execute processes. The learning apparatus 310 has hardware, such as a CPU, a graphics processing unit (GPU), an application-specific integrated chip (ASIC), and a field-programmable gate array (FPGA), capable of executing learning processes. Examples of the learning apparatus 310 include a personal computer, a server, a smartphone, a printer, and the like.

the data bus 309 communicably connects blocks to one another. The blocks include the CPU 301, the ROM 302, the RAM 303, the image processing unit 304, the scanning unit 305, the operation unit 306, the drive unit 307, and the data communication unit 308.

Note that the reading apparatus 100 includes the image processing unit 304 in the example of FIG. 3, but may not include the image processing unit 304. In a case where the image processing unit 304 does not include the reading apparatus 100, the CPU 301, for example, performs the image processing to be executed by the image processing unit 304. Alternatively, an information processing apparatus connected through the data communication unit 308 may perform the image processing to be executed by the image processing unit 304. This information processing apparatus may be a personal computer. Alternatively, the information processing apparatus may be a server that provides a service.

Also, in the present embodiment, the reading apparatus 100 is a flatbed reading apparatus, but may be a sheet-fed reading apparatus. In the case of a flatbed reading apparatus, the reading unit 103 moves relative to a fixed document. In the case of a sheet-fed reading apparatus, a document is moved related to a fixed reading unit. In this case, the document is moved by an automatic document feeder (ADF).

### <Image Processing>

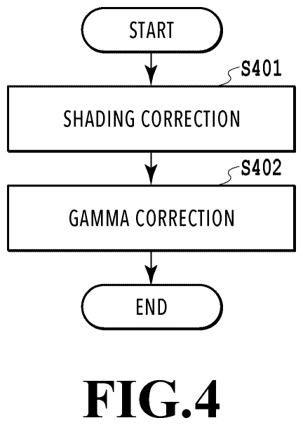

FIG. 4 is a flowchart illustrating an example of the image processing to be executed by the image processing unit 304. The flowchart of FIG. 4 is executed each time the operation unit 306 detects a press on any of the buttons corresponding respectively to the plurality of scan modes. Note that each symbol “S” in the following description of the flowchart means a step.

In S401, the image processing unit 304 performs shading correction on image data generated by the scanning unit 305. The shading correction corrects variation of the image capturing element (sensor 203). For example, in the shading correction, correction data for correcting uneven lighting or lens characteristics is generated based on white reference data and black reference data prepared in advance. The image data is corrected using this correction data to adjust unevenness in the brightness of the image in the image data. After the shading correction is performed, the image processing unit 304 advances the processing to S402.

In S402, the image processing unit 304 performs gamma correction on the image data subjected to the shading correction. The gamma correction corrects the luminance values of the image so that the rendered image appears natural to the human eye. For example, in the gamma correction, the image data subjected to the shading correction is corrected using a gamma value table held in advance in the ROM 302 to adjust the brightness of the whole image in the image data.

### <Machine Learning>

Next, machine learning used in the present embodiment will be described. The machine learning involves a learning process and an estimation process. The learning process is a process of learning model parameters of a machine learning model. The estimation process is a process of causing the machine learning model to execute a process using the learned parameters. In the present embodiment, an image generation model is used as the machine learning model. The image generation model is a machine learning model that outputs images.

### <<Machine Learning Model>>

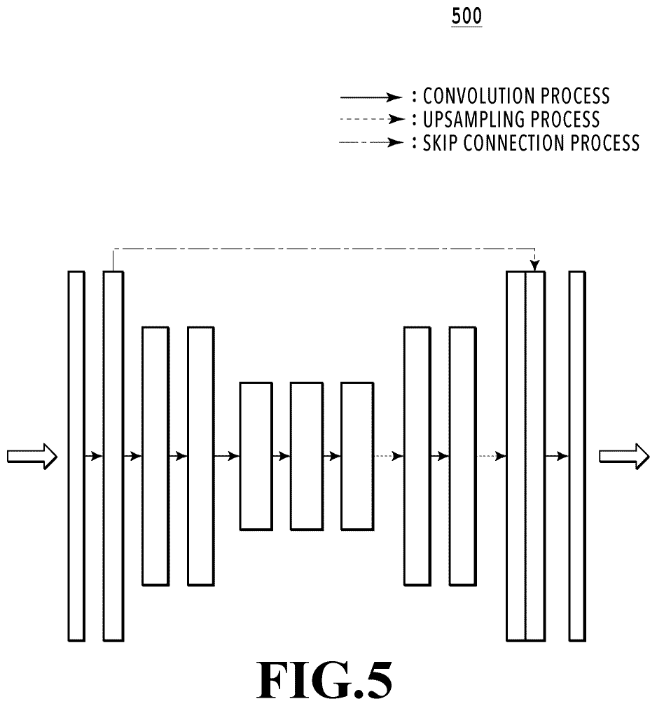

FIG. 5 is a diagram illustrating an example of a machine learning model 500. The machine learning model 500 is an image generation model. Moreover, the machine learning model 500 is a machine learning model based on a convolutional neural network (CNN model).

In the example of FIG. 5, each rectangle represents image data. The length of this rectangle in the vertical direction represents the number of pixels in the image data. The larger the number of pixels, the longer the vertical length of the rectangle representing the image data. The length of the rectangle in the horizontal direction represents the number of channels in the image data. The larger the number of channels, the longer the horizontal length of the rectangle representing the image data.

Also, in the example of FIG. 5, each arrow represents a process. Specifically, each solid arrow represents a convolution process. Each dashed arrow represents an upsampling process. The long dashed short dashed arrow represents a skip connection process. The convolution process includes a calculation that moves a filter over the image to derive the sum of products between the portion of the image on which the filter is placed and the filter. Details of this convolution process will be described later. The upsampling process is a process that increases the number of pixels of the image data. In the present embodiment, the upsampling process is executed using bilinear interpolation but is not limited to this. For example, the upsampling process may be executed using different interpolation such as nearest interpolation or bicubic interpolation. Alternatively, the upsampling process may be executed using deconvolution. The skip connection process is a process that connects the output of a layer to a later layer. Specifically, it connects the image data before upsampling processes and the image data after the upsampling processes in the channel direction.

Image data with three channels, namely R, G and B channels, for example, is input into the machine learning model 500. In response to the input of the image data, the machine learning model 500 starts processing. Specifically, the input image data is subjected to a first convolution process. Then, the image data obtained by the first convolution process is subjected to a second convolution process involving downsampling. Then, the image data obtained by the second convolution process is subjected to a third convolution process. Then, the image data obtained by the third convolution process is subjected to a fourth convolution process involving downsampling. Then, the image data obtained by the fourth convolution process is subjected to a fifth convolution process and a sixth convolution process in this order. Then, the image data obtained by the sixth convolution process is subjected to an upsampling process. Then, the image data obtained by the upsampling process is subjected to a seventh convolution process. Then, the image data obtained by the seventh convolution process is subjected to an upsampling process. Then, the image data obtained by the upsampling process is subjected to a skip connection process. In the example of FIG. 5, the image data obtained by the first convolution process is connected to the image data obtained by the upsampling process. Then, the image data obtained by the skip connection process is subjected to an eighth convolution process. This image data obtained by the eighth convolution process is output as the result of the processing by the machine learning model 500.

As described above, the structure of the machine learning model 500 has eight convolution process layers, two upsamplings, and one skip connection, but may be a different structure. For example, at least one of the number of layers and the number of channels may be increased. While increasing at least one of the number of layers and the number of channels increases the processing load, it is expected to improve accuracy.

### <<Convolution Process>>

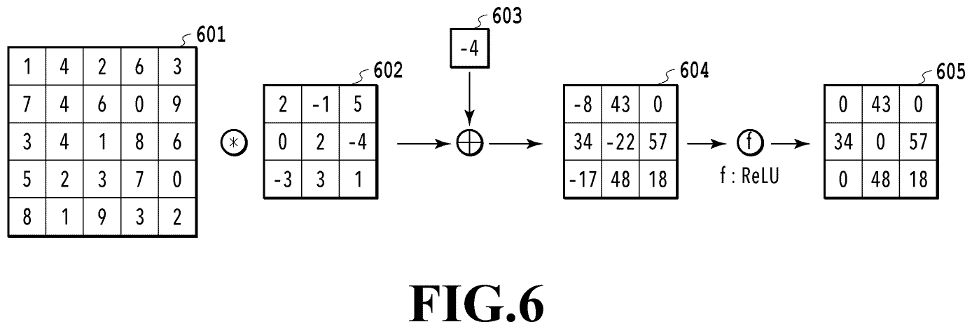

FIG. 6 is a diagram for describing a convolution process. In a convolution process, first, a convolution calculation is performed with input data 601 and weight 602. Then, a bias 603 is added to the result of this convolution calculation to obtain intermediate data 604. Then, the intermediate data 604 is converted by an activation function f to obtain output data 605. The activation function f is the rectified linear unit (ReLU), but an activation function other than ReLU may be used instead. In a case where the activation function f is ReLU, all values less than 0 will be 0 in the output data 605. Note that the weight 602 and the bias 603 are model parameters, are learned in the learning process. The weight 602 is also called a filter or a window.

In the example of FIG. 6, the numbers of channels in the input data 601, the intermediate data 604, and the output data 605 are all one but are not limited to this. Also, the size of the weight 602 is 3×3 but is not limited to this. For example, in a case where the number of channels in the input data 601 is M, the number of channels in the intermediate data 604 is N, and the size of the weight 602 is K×K, the weight 602 is a (K×K×M×N)-dimensional matrix. In this case, the bias 603 is an N-dimensional vector.

Also, in the example of FIG. 6, the sizes of the input data 601 and the intermediate data 604 are different but can be made equal. For example, the sizes of the input data 601 and the intermediate data 604 will be equal by performing a padding process on the input data 601 and performing a convolution calculation with the result of that padding process and the weight 602. The padding process is a process that adds pixels with a value 0 or the like around the input data 601.

Also, in the example of FIG. 6, the stride in the convolution process is 1, but may be other than 1. Note that the stride is the width across which the filter (weight 602) is moved. For example, in a case where the stride is 2, the input data 601 is subjected to a convolution calculation in a pixel-by-pixel manner with the weight 602. In this case, the number of pixels of the intermediate data 604 will be ¼ of the number of pixels of the input data 601. This makes it possible to implement the convolution processes involving downsampling, each of which is one of the processes by the machine learning model 500 described above. Note that the downsampling does not need to a convolution process. For example, it may be downsampling by max pooling.

### <<Learning Setting Screen>>

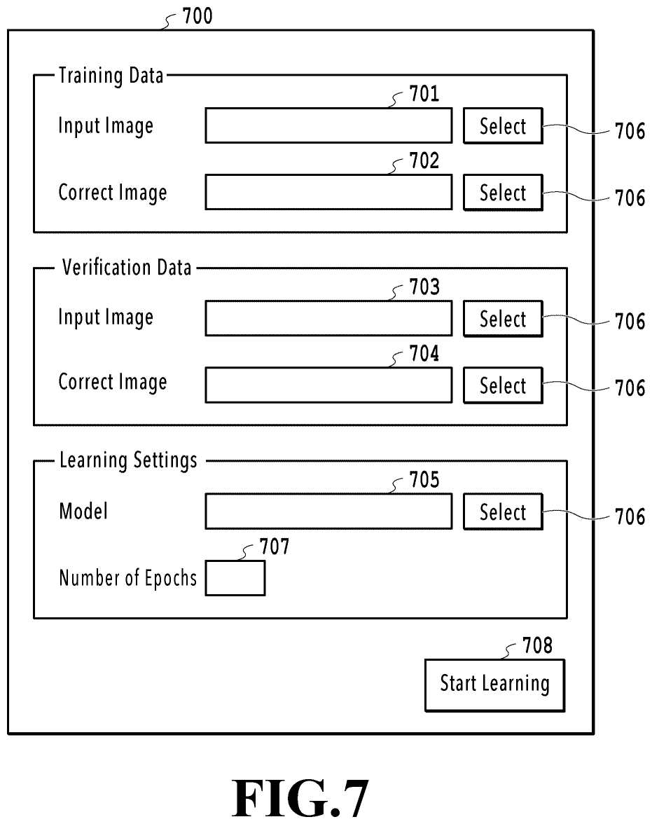

FIG. 7 is a diagram illustrating an example of a learning setting screen 700. The learning setting screen 700 is a setting screen for a learning process. This learning setting screen 700 is displayed by the learning apparatus 310.

For example, in response to receiving an instruction to launch an executable file, the learning apparatus 310 displays the learning setting screen 700, which is a user interface, on a display included in the learning apparatus 310. The executable file is stored in a storage device accessible by the learning apparatus 310. Note that the executable file is not limited to one which directly displays the learning setting screen 700 in response to being launched. For example, an executable file may be employed which displays a launcher screen in response to being launched, and displays the learning setting screen 700 in a case where an item for configuring learning settings provided in that launcher screen is selected.

The learning setting screen 700 is provided with a plurality of text boxes. In each text box, a folder path to a folder stored in a storage device accessible by the learning apparatus 310 is set.

A first text box 701 is a text box for setting a path to a folder storing input images to be used for the learning. A second text box 702 is a text box for setting a path to a folder storing correct images to be used for the learning. A third text box 703 is a text box for setting a path to a folder storing training images to be used for accuracy verification in the learning. A fourth text box 704 is a text box for setting a path to a folder storing correct images to be used for the accuracy verification in the learning. By using verification data besides training data, it is possible to obtain model parameters that do not overfit to the training data and have good generalization performance (learned parameter). A fifth text box 705 is a text box for setting a path to a folder for a model structure to be used for the learning. A model structure indicates the structure of a machine learning model. That is, a model structure is information indicating a structure defining a machine learning model. For example, a model structure indicates the types, number, and the like of layers. The model structure is saved in a text format as structured data in the folder. In the folder, pieces of structured data corresponding to a plurality of machine learning models including the machine learning model 500 are saved.

Also, the learning setting screen 700 is provided with select buttons 706 respectively for the plurality of text boxes. In a case where the user presses a select button 706, a selection dialogue is displayed on the display, and the user selects (designates) a folder in the selection dialogue, in response to which the folder path to that folder is set in the text box.

Also, the learning setting screen 700 is provided with a numerical value box 707 and a learning start button 708. The numerical value box 707 is a text box for setting the number of epochs for the learning. The learning start button 708 is an operation part for accepting an operation to start the learning process. In response to a press on the learning start button 708, the learning apparatus executes the learning process based on the contents of the settings set on the learning setting screen 700.

### <<Learning Process>>

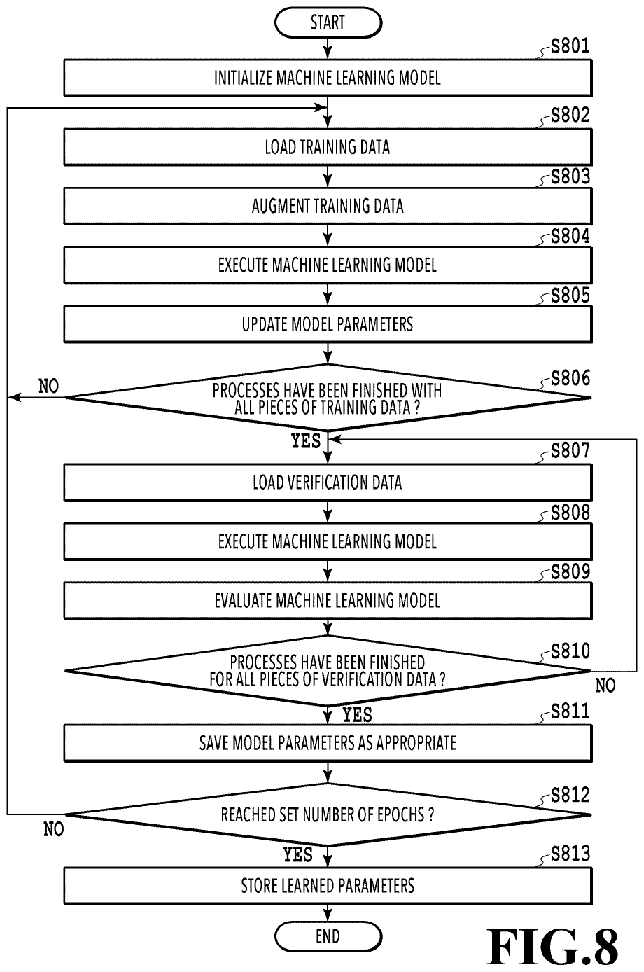

FIG. 8 is a flowchart illustrating an example of a learning process. The symbol “S” in the following description of the flowchart represents a step. The learning apparatus 310 implements the series of processes illustrated in the flowchart of FIG. 8 (learning process) by executing a program. The learning process starts in a case where the learning apparatus 310 accepts an instruction to start learning. The instruction to start learning is supplied to the learning apparatus 310 in response to a press on the learning start button 708.

In S801, the learning apparatus 310 initializes a machine learning model. Specifically, the learning apparatus 310 loads structured data from the folder path set in the fifth text box 705, and recognizes the machine learning model corresponding to that structured data as the machine learning model to be executed. Also, the learning apparatus 310 sets initial values of the model parameters to be used for the machine learning model to be executed. After the machine learning model is initialized, the learning apparatus 310 advances the process to S802.

Note that the initial values of the model parameters may be random values generated by a random number generator. Alternatively, the initial values of the model parameters may be values generated by an initialization algorithm, such as Xavier initialization or He initialization. Alternatively, the initial values of the model parameters may be values learned in advance using large datasets for other tasks such as image recognition.

In S802, the learning apparatus 310 loads a piece of training data. In the present embodiment, the learning apparatus 310 loads the training data from the folder paths set in the first text box 701 and the second text box 702. That is, the training data includes a training pair being a pair of an input image and a correct image. After the training data is loaded, the learning apparatus 310 advances the processing to S803.

Note that the input image is an image including a background portion and printed portions. The input image is also called a sample image or a training image. The correct image is an image obtained by converting the background portion of the input image into a color corresponding to the background. A plurality of training pairs are stored in a storage device accessible by the learning apparatus 310. The method of managing the training pairs is not particularly limited. For example, the images forming each training pair are managed are managed with the same file name. Alternatively, the images forming each training pair are managed with file names each having a prefix indicating an input image or a correct image. Alternatively, the images forming each training pair are recorded and managed in table data.

In S803, the learning apparatus 310 is performs augmentation of the training data loaded in S802. The augmentation of the training data is a process that generates various pieces of training data from one piece of training data by processing the piece of training data. After the augmentation of the training data is performed, the learning apparatus 310 advances the processing to S804.

Note that examples of the processing of the training data include inversion, rotation, trimming, and the like. Also, the augmentation of the training data does not necessarily need to be performed during the learning process. The augmentation of the training data may be performed in advance before the learning process. In this case, the process of S803 is not executed.

In S804, the learning apparatus 310 causes the machine learning model corresponding to the structured data loaded in S801 to execute a process with the input image in the training data as an input, and obtains the result of that process as an output image. After the output image is obtained, the learning apparatus 310 advances the processing to S805.

In S805, the learning apparatus 310 updates the model parameters. For example, the learning apparatus 310 updates the model parameters in such a way as to minimize the error between the output image obtained in S804 and the correct image paired with the input image input into the machine learning model in S804. In this case, the mean squared error, for example, is used as a function for calculating the error (loss function). Further, a gradient is calculated using error back propagation to update the model parameters. Note that the mean absolute error, perceptual similarity, or the like may be used as the loss function. After the model parameters are updated, the learning apparatus 310 advances the processing to S806.

In S806, the learning apparatus 310 judges whether the processes of S802 to S805 (primary process) have been finished with all pieces of training data stored in the folders. The learning apparatus 310 returns the process to S802 if the primary process has not been finished, and advances the process to S807 if the primary process has been finished.

In S807, the learning apparatus 310 loads a piece of verification data. In the present embodiment, the learning apparatus 310 loads the verification data from the folder paths set in the third text box 703 and the fourth text box 704. That is, the verification data in the present embodiment includes a verification pair being a pair of an input image and a correct image. After the verification data is loaded, the learning apparatus 310 advances the processing to S808.

Note that a plurality of verification pairs are stored in a storage device accessible by the learning apparatus 310. The input image included in the verification data is different from the input image included in the training data. Similarly, the correct image included in the verification data is different from the correct image included in the training data. Using images that are not included in the training data for the verification data makes it possible to verify whether the machine learning model does not overfit to the training data and has appropriate generalization performance.

In S808, the learning apparatus 310 causes the machine learning model corresponding to the structured data loaded in S801 to execute a process with the input image in the verification data as an input, and obtains the output image output from the machine learning model as the result of that process. After the output image is obtained, the learning apparatus 310 advances the processing to S809.

In S809, the learning apparatus 310 evaluates the accuracy of the machine learning model. For example, the learning apparatus 310 calculates an evaluation value using the output image obtained in S808 and the correct image paired with the input image input into the machine learning model in S808. In the present embodiment, the sum of the peak signal-to-noise ratio (PSNR) indicating the difference from the original pixels and the learned perceptual image patch similarity (LPIPS) indicating perceptual similarity between the images is calculated as the evaluation value. Note that an image quality evaluation index such as the structural similarity index measure (SSIM) may be calculated as the evaluation value. Alternatively, the reciprocal value of the least square error between the estimated image and the correct image may be calculated as the evaluation value. After the accuracy of the machine learning model is evaluated, the learning apparatus 310 advances the processing to S810.

In S810, the learning apparatus 310 judges whether the processes of S807 to S809 (secondary process) have been finished for all pieces of verification data stored in the folders. The learning apparatus 310 returns the process to S807 if the secondary process has not been finished, and advances the process to S811 if the secondary process has been finished.

In S811, the learning apparatus 310 saves the updated model parameters as appropriate. First, the learning apparatus 310 associates the current model parameters and the evaluation value calculated in S809 with each other. Then, if the evaluation value is higher than the highest evaluation value in the learning process, the learning apparatus 310 saves the model parameters and the evaluation value to a storage device and updates the highest evaluation value with the current evaluation value. Thereafter, the learning apparatus 310 advances the processing to S812. Note that the initial value of the highest evaluation value is 0. Thus, the model parameters and the evaluation value are saved to the storage device without fail.

In S812, the learning apparatus 310 judges whether the current number of repetitions of learning has reached the number of epochs set in the numerical value box 707. The number of repetitions of learning is incremented in a case where it is confirmed that the secondary process has been finished, for example. The learning apparatus 310 returns the process to S802 if the current number of repetitions of learning has not reached the number of epochs, and advances the process to S813 if the current number of repetitions of learning has not reached the number of epochs.

In S813, the learning apparatus 310 controls the ROM 302, which is a storage unit of the reading apparatus 100, such that it stores the model parameters saved in the storage device as learned parameters. After the learned parameters are stored, the series of processes illustrated in the flowchart of FIG. 8, or the learning process, is terminated.

Note that, in the above learning process, the learned parameters are stored in a case where the number of repetitions of learning reaches the number of epochs, but the learning process is not limited to this. For example, in a case where the highest evaluation value does not get updated in S811 a certain number of times in a row, the learning apparatus 310 may consider that the optimization process has reached convergence, control the ROM 302 such that it stores the learned parameters, and then terminate the learning process.

### <<Training Data Creation Process>>

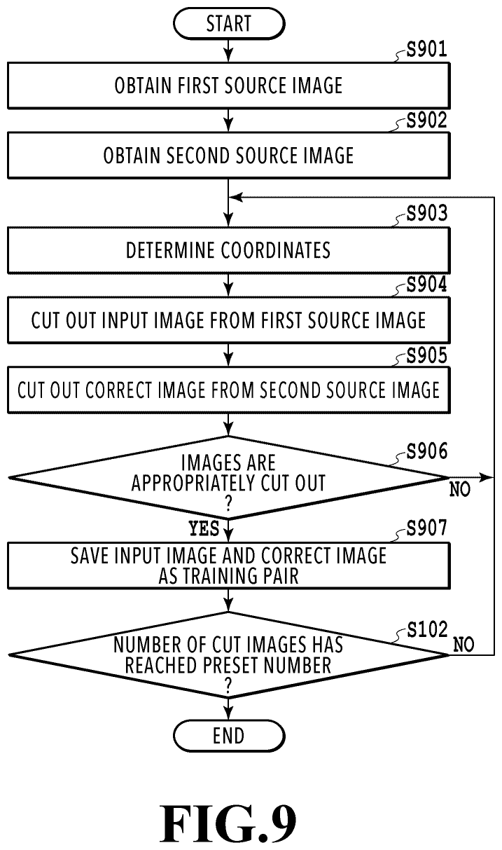

FIG. 9 is a flowchart illustrating an example of a training data creation process. The learning apparatus 310 executes the series of processes illustrated in the flowchart of FIG. 9 (training data creation process). For example, in response to a press on a button included in the learning apparatus 310, the learning apparatus 310 accepts an instruction to create training data and starts a training data creation process.

In S901, the learning apparatus 310 obtains a first source image as an image from which to make an input image to be used in a learning process. For example, the learning apparatus 310 requests the reading apparatus 100 to perform reading at a predetermined resolution and obtains the first source image from the reading apparatus 100. This first source image is image data obtained by reading a printed product placed on the document plate 102 into image data with a required resolution and performing the image processing illustrated in FIG. 4 on that image data. After obtaining the first source image, the learning apparatus 310 advances the process to S902.

The surface of the printed product (document) includes a background portion and printed portions. The background portion is a portion of the print medium, such as a paper surface, where nothing is printed (paper white portion). The printed portions are portions where patterns are printed with dots using inks, toners, or the like (ejection portions). To distinguish the background portion and the printed portions, the reading resolution for the first source image obtained in S901 needs to be more than or equal to a resolution with which dot patterns are readable. For example, in a case where the diameter of one dot in inkjet printing is about 40 μm, the resolution may be 150 dpi or more. In other words, the ratio of the area of one dot to one pixel is about 1/16. Note that a plurality of types of dot patterns may be included instead of one type of dot pattern. Including a plurality of types of dot patterns provides robustness.

In S902, from the first source image obtained in S901, the learning apparatus 310 obtains a second source image as an image from which to make a correct image to be used in a learning process. For example, the learning apparatus 310 converts the pixels at or above a threshold value among the pixels in the first source image obtained in S901 using a lookup table to generate a candidate image. Further, the learning apparatus 310 displays the generated candidate image on a display accessible by the learning apparatus 310. The user judges whether the background portion and the printed portions are correctly distinguished, and inputs the result of that judgment into the learning apparatus 310. If receiving a judgment result indicating that the background portion and the printed portion are not correctly distinguished, the learning apparatus 310 changes the above-mentioned threshold value, generates a candidate image again, and displays it on the display. On the other hand, if receiving a judgment result indicating that the background portion and the printed portions are correctly distinguished, the learning apparatus 310 obtains the candidate image as the second source image. After obtaining the second source image, the learning apparatus 310 advances the process to S903.

In S903, the learning apparatus 310 determines the coordinates of a region to be cut out from the images. These coordinates may be determined at random or determined in accordance with the user's operation. After the coordinates are determined, the learning apparatus 310 advances the process to S904.

In S904, the learning apparatus 310 cuts out the input image to be used in learning from the first source image obtained in S901 based on the coordinates determined in S903, and advances the process to S905. In S905, the learning apparatus 310 cuts out the correct image to be used in learning from the second source image obtained in S902 based on the coordinates determined in S903, and advances the process to S906.

In S906, the learning apparatus 310 judges whether the cut input image and correct image are appropriately cut out. If at least one of the input image and the correct image does not include at least one of the background portion and the printed portions, the learning apparatus 310 judges that the input image and the correct image are not appropriately cut out, and returns the process to S903. On the other hand, if the input image and the correct image each include the background portion and the printed portions, the learning apparatus 310 judges that the input image and the correct image are appropriately cut out, and advances the process to S907.

In S907, the learning apparatus 310 stores the input image obtained and the correct image as a training pair in a predesignated storage location, and advances the process to S908. In S908, the learning apparatus 310 judges whether the number of cut images has reached a preset number. If the number of cut images has not reached the preset number, the learning apparatus 310 returns the process to S903. On the other hand, if the number of cut images has reached the preset number, the learning apparatus 310 terminates the series of processes illustrated in the flowchart of FIG. 9, or the training data creation process.

The user can perform an operation to execute the training data creation process each time the user places a printed product on the document plate 102 from among a plurality of printed products. By doing so, a plurality of training pairs can be stored in the storage device. Note that verification data can be created by performing a creation process in a similar manner to that described above.

Note that the training data creation process is not limited to the process described in the flowchart of FIG. 9. For example, the first source image obtained in S901 may be an input image, and the second source image obtained in S902 may be a correct image. In this case, the processes of S903 to S907 are not performed.

Also, the first source image is obtained by causing the reading apparatus 100 to perform reading, but the present disclosure is not limited to this. For example, the learning apparatus 310 may perform image processing that simulates reading by the reading apparatus 100 on data for printing dot patterns on a print medium to generate a first source image including a background portion and printed portions. In this case, the first source image is obtained without causing the reading apparatus 100 to actually execute reading, thus reducing the processing load.

### <<Specific Examples of Training Data>>

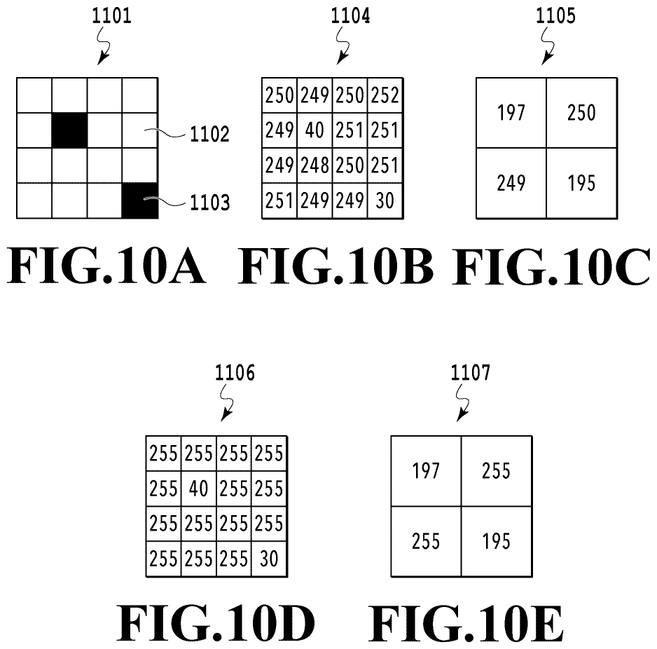

FIGS. 10A to 10E are diagrams illustrating example images for describing training data. A patch 1101 represents an example of a portion of an image obtained by reading at 1200 dpi a printed product printed by inkjet printing. White pixels 1102 in the patch 1101 represent white paper corresponding to a background portion. Also, black pixels 1103 in the patch 1101 represent dots corresponding to printed portions.

A pixel value patch 1104 indicates the pixel value of each pixel in the patch 1101. Specifically, the pixel value patch 1104 indicates the pixel value of each pixel expressed on a 256-level scale. The closer the color is to black, the smaller the pixel value is. Conversely, the closer the color is to white, the larger the pixel value is. The pixel values of the white pixels 1102 in the patch 1101 are 251. The pixel values of the black pixels 1103 in the patch 1101 are 30.

A pixel value patch 1105 indicates the pixel value of each pixel in a portion of an image obtained by reading the same printed product as that of the patch 1101 at 600 dpi, the portion being the same as that of the patch 1101. In a case where the reading resolution is different, the same location on the paper surface is represented by a different number of pixels. For this reason, the pixel value patch 1105 does not refer to data with the same coordinates as those of the white pixel 1102 in the patch 1101. For example, in a case where the reading resolution at which the reading unit 103 performs reading becomes half, the average of the pixel values of each 2×2 pixels in the pixel value patch 1104 is calculated as the pixel value of that range. While the smallest and largest pixel values in the pixel value patch 1104 are 30 and 251, respectively, the smallest and largest values in the pixel value patch 1105 are 195 and 250, respectively.

As described above, as the reading resolution becomes lower, the difference in density between the background portion and the printed portions becomes smaller, making it difficult to read the dot patterns of the printed portions. Then, as long as the reading resolution is more than or equal to a resolution with which dot patterns printed on the document are readable, the background portion and the printed portions can be distinguished.

A pixel value patch 1106 represents a correct image created from the pixel value patch 1104 in a case where the pixel value patch 1104 is an input image. The pixel values of the white pixels 1102 in the patch 1101 are converted to 255, which is the largest value in a case of expressing density on a 256-level scale. The pixel values of the black pixels 1103 in the patch 1101 are not converted and remains as is.

A pixel value patch 1107 represents a correct image created from the pixel value patch 1105 in a case where the pixel value patch 1105 is an input image. Regions formed solely of white pixels 1102 in the patch 1101 are converted to 255, which is the largest value in a case of expressing density on a 256-level scale. The values of regions including pixels corresponding to the black pixels 1103 in the patch 1101 remain as is.

In the present embodiment, input images in each of which at least the pixel values of the background portion vary and corresponding correct images in which the varying pixel values of the background portion are corrected to be constant (within a predetermined range) are used in learning.

The resolution of the correct images may be adjusted to the reading resolution of the reading apparatus 100 for a background correction process to be described later to enhance the accuracy of the background correction process. Here, the resolution of the input images and the resolution of the correct images do not need to be adjusted to the reading resolution for the background correction process. For example, a set of a high-resolution input image and a high-resolution correct image may be prepared in advance and, in a case of performing the background correction process at a low resolution, these images may be reduced (downsampled). This reduces the load of the data creation. Examples of the method of creating a correct image from an input image include a method in which rough conversion is performed by a rule-based thresholding process or the like and detailed conversion is performed by manually identifying the background portion and the printed portions. This method allows for accurate identification of the background portion and the printed portions. For example, the copy-forgery-inhibited pattern of a printed product subjected to copy-forgery-inhibited pattern printing may be manually excluded from the background portion. This prevents loss of the function of the copy-forgery-inhibited pattern printing. As a result, the learning accuracy is enhanced. The method of creating a correct image from an input image also includes a method in which the digital data used to print the document is used as the correct data. This can eliminate the effort required to generate the correct data and thus reduces the load of the training data generation. Also, the correct image may be created by performing digital image processing that simulates reading by the reading apparatus 100 on the digital data used to print the document. This can eliminate the effort required to generate the correct data and also create correct images for input images similar to the image obtained by the actual scan.

The pixel values of the white pixels 1102 in the pixel value patch 1104 vary. This is because varying shadows are formed on the surface of the document due to the fibers of the document, asperities on the document, and the like. Also, the pixel values of the black pixels 1103 in the pixel value patch 1104 vary as well. This is because the densities of dots formed on the surface of the document vary due to the condition under which the document was printed, the printed color, and the like.

It is difficult to precisely specify the causes of the varying shadows formed on a document surface and the varying densities of dots formed on the document surface. For this reason, in the present embodiment, the above-described learning process is performed using the shapes of document surfaces each including at least one of varying shadows formed on the document surface and varying densities of dots formed on the document surface. That is, the shapes of document surfaces are used to learn the model parameters of a machine learning model, and the learned parameters are stored in the ROM 302.

### <Background Correction Process>

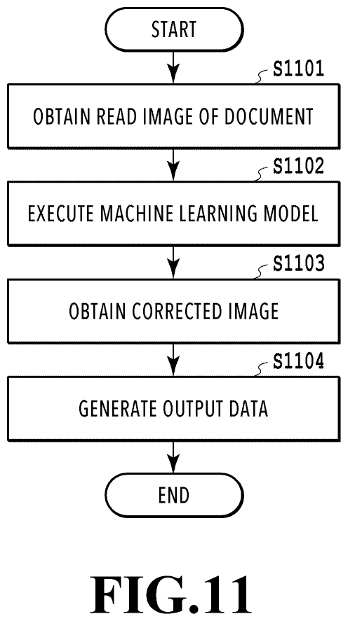

FIG. 11 is a flowchart illustrating an example of the background correction process in the present embodiment. The CPU 301 implements the series of processes illustrated in the flowchart of FIG. 11 (background correction process) by loading a program stored in the ROM 302 to the RAM 303 and executing it. The background correction process starts in response to a press on a button for executing a scan mode.

In S1101, the CPU 301 obtains a read image of a document placed on the document plate 102. Specifically, the CPU 301 controls the drive unit 307 to cause the reading unit 103 to read the document placed on the document plate 102. Then, the CPU 301 controls the scanning unit 305 to generate image data corresponding to the scan mode based on a signal output from the reading unit 103. Then, the CPU 301 controls the image processing unit 304 to cause the image processing unit 304 to execute the image processing illustrated in FIG. 4. The image data subjected to this image processing is the read image of the document. After the read image of the document is obtained, the CPU 301 advances the processing to S1102.

In S1102, the CPU 301 causes a machine learning model to execute a process. Specifically, the CPU 301 transmits the learned parameters stored in the ROM 302 and the read image obtained in S1101 to the learning apparatus 310 along with a model execution request. Thereafter, the CPU 301 advances the processing to S1103.

The model execution request is a request to cause the machine learning model to execute a process with the read image as an input by using the learned parameters. In response to accepting this model execution request, the learning apparatus 310 causes the machine learning model to execute a process with the read image as an input by using the learned parameters. The machine learning model outputs an image as the result of this process, and the learning apparatus 310 transmits that image as a response to the model execution request to the reading apparatus 100.

In S1103, the CPU 301 obtains a corrected image. Specifically, the CPU 301 obtains the image transmitted as a response to the model execution request from the learning apparatus 310. This image is the result of performing a pixel correction process that is a process of correcting the colors of the pixels of the background portion. That is, in the present embodiment, the process by the machine learning model corresponds to the pixel correction process. The CPU 301 obtains the image transmitted as the result of the process by the machine learning model from the learning apparatus 310 as a corrected image. After receiving the image transmitted from the learning apparatus 310, the CPU 301 advances the process to S1104.

In S1104, the CPU 301 generates output data. For example, the CPU 301 converts the file format of the image obtained in S1103. The file format may be a preset format or designated based on the user's operation on the operation part 104. Examples of the file format file include bitmap, Joint Photographic Experts Group (JPEG), Portable Network Graphics (PNG), and the like. After the output data being the data of the image subjected to the file format conversion is obtained, the series of processes illustrated in the flowchart of FIG. 11, or the background correction process, is terminated.

As described above, according to the present embodiment, it is possible to appropriately correct an image. For example, the reading apparatus 100 includes the ROM 302 serving as a storage unit storing learned parameters that are the model parameters of machine learning models trained for correction of the backgrounds of document surfaces by using the shapes of document surfaces. The CPU 301 of the reading apparatus 100 causes a machine learning model to execute a process with a read image of a document obtained based on reading by the reading unit 103 as an input by using the learned parameters. The CPU 301 of the reading apparatus 100 obtains an image output as the result of this process from the machine learning model as a corrected image subjected to a pixel correction process that corrects the colors of the pixels of the background portion in the read image. In this way, even in a case where varying shadows are formed on the document surface and/or the densities of dots formed on the document surface vary, it is possible to appropriately correct the color of the background portion while maintaining the colors of the printed portions.

Note that in the present embodiment, a set of learned parameters corresponding to one resolution is stored in the ROM 302, but sets of learned parameters corresponding respectively to a plurality of resolutions may be stored in the ROM 302. In this case, a learning process is performed for each of the plurality of resolutions, and the sets of learned parameters corresponding to the respective resolutions are stored in the ROM 302. The reading apparatus 100 causes a machine learning model to execute a process using the learned parameters corresponding to the reading resolution with which the reading unit 103 performs reading. In this way, a high background correction effect can be achieved.

Also, in the present embodiment, the entire read image is subjected to a pixel correction process, but the read image may be divided into a plurality of regions and each region may be subjected to the pixel correction process. This can reduce the memory consumption and also improve the processing speed. Note that the regions may be in a rectangular shape or a strip shape.

Also, in the present embodiment, the reading apparatus 100 is a single-function scanner including only the scanning unit 305, but the present disclosure is not limited to this. For example, the reading apparatus 100 may be a copying apparatus including the scanning unit 305 and a unit other than the scanning unit 305. The copying apparatus is also called a multifunction peripheral (MFP).

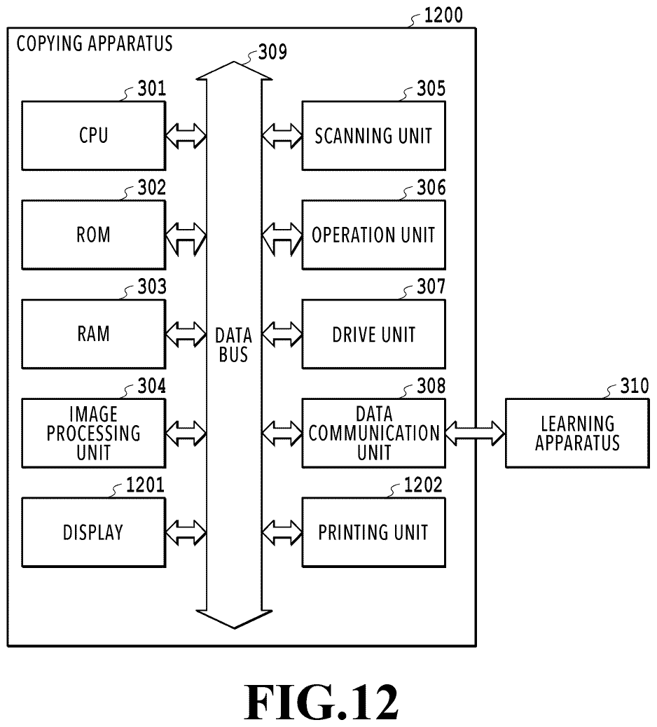

FIG. 12 is a block diagram illustrating an example of a configuration of the reading apparatus 100 in a case where it is a copying apparatus. The copying apparatus further includes a display 1201 and a printing unit 1202 in addition to the configuration of the reading apparatus 100 described above. The display 1201 has a liquid crystal layer and a touch sensor layer. The display 1201 is capable of displaying images such as read images, user interface screens, and the like. Also, the display 1201 is capable of accepting various pieces of information in response to the user's operations on the user interface screens. The printing unit 1202 is a unit capable of printing images and the like.

Including the display 1201 makes it possible to execute a scan mode with software keys on a user interface screen without a button included in the operation part 104 (hardware key). For example, it is possible to set a desired reading resolution from among the plurality of reading resolutions corresponding to the color modes and the monochrome mode. Note that the display 1201 may be included in a single-function scanner. Also, including the printing unit 1202 makes it possible to print a read image subjected to the background correction process.

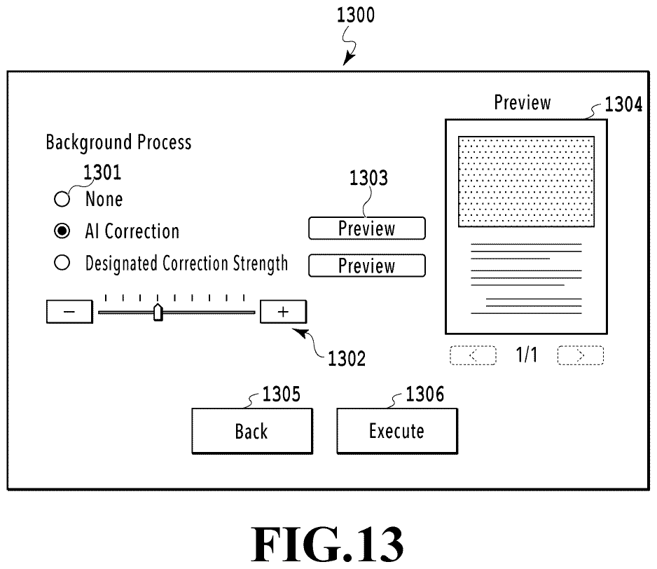

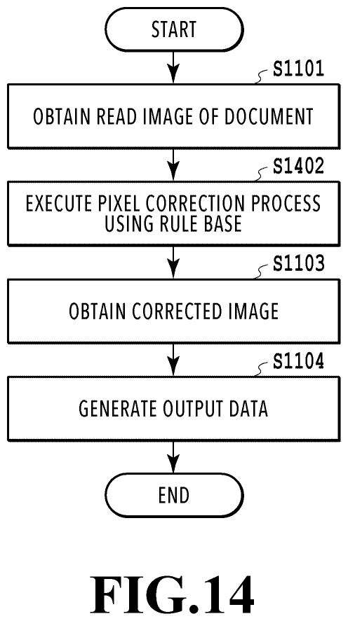

Also, in the present embodiment, the reading apparatus 100 may be capable of switching between using a machine learning model to correct the pixel values of the background portion and using a rule base to correct the pixel values of the background portion. FIG. 13 is a diagram illustrating an example of a setting screen 1300. FIG. 14 is a flowchart illustrating an example of the background correction process using a rule base. An example in which it is possible to switch between using a machine learning model to correct the pixel values of the background portion and using a rule base to correct the pixel values of the background portion will be described below using FIGS. 13 and 14.

The setting screen 1300 is displayed on a display of an information terminal connected to the reading apparatus 100 through the data communication unit 308, for example. The information terminal may be a personal computer, a smartphone, or the like. In a case where the reading apparatus 100 includes the display 1201, the setting screen 1300 may be displayed on the display 1201.

The setting screen 1300 is displayed by the CPU 301. The CPU 301 displays the setting screen 1300, for example, in a case where a setting item for a background process is selected from among setting items on a menu screen (not illustrated) displayed on the display.

On the setting screen 1300, “AI Correction,” “Designated Correction Strength,” or “None” may be selected. “AI Correction” represents a correction mode that corrects the colors (pixel values) of the pixels of the background portion using a machine learning model. “Designated Correction Strength” represents a correction mode that corrects the colors (pixel values) of the pixels of the background portion using a rule base. “None” represents a non-correcting mode that does not correct the colors of the pixels of the background portion.

In the example of FIG. 13, radio buttons 1301 corresponding respectively to the above modes are provided. The user may select one of the radio buttons 1301 corresponding respectively to the modes to select one desired mode. The selected radio button 1301 becomes turned on, while the unselected radio buttons 1301 are turned off.

The setting screen 1300 is provided with a strength adjustment item 1302. The strength adjustment item 1302 is an operation part for designating strength. The strength adjustment item 1302 becomes operable in a case where “Designated Correction Strength” is selected. In the example of FIG. 13, a gauge bar, an indicator, a “−” button, and a “+” button are displayed as the strength adjustment item 1302. Pressing the “−” button or the “+” button moves the indicator, which indicates the current strength, over the gauge bar. The gauge bar represents a strength adjustment range. The farther the indicator moves toward the “−” side of the gauge bar, the lower the strength becomes. On the other hand, the farther the indicator moves toward the “+” side of the gauge bar, the higher the strength becomes. The user may press the “−” button or the “+” button to designate a desired strength.

Note that the strength in a case of correcting the pixel values of the background portion using a rule base means the degree of correction of the pixel values of the background portion, and corresponds to the conditions of the rule base. In the present embodiment, a process of correcting the pixel values of the background portion using a rule base is a process of comparing each pixel in the image with a threshold value and correcting the pixel values of pixels greater than or equal to the threshold value in accordance with a lookup table. In the present embodiment, the threshold value is set as the strength in this process.

The setting screen 1300 is provided with preview buttons 1303, an image region 1304, a back button 1305, and an execute button 1306. The preview buttons 1303 are each an operation part for accepting display of a preview image in the image region 1304. The image region 1304 displays a preview image in a case where the selected correction mode is executed. The back button 1305 is an operation part for accepting an instruction to return to the menu screen. Pressing the back button 1305 displays the menu screen in a state where the current settings for the background correction process are maintained. The execute button 1306 is an operation part for accepting execution of the selected correction mode.

In a case of accepting “AI Correction,” the CPU 301 corrects the colors (pixel values) of the pixels of the background portion using a machine learning model. In this case, the CPU 301 executes the background correction process illustrated in the flowchart of FIG. 11. In a case of accepting “Designated Correction Strength,” the CPU 301 corrects the colors (pixel values) of the pixels of the background portion using a rule base, instead of causing a machine learning model to execute the process. In this case, the CPU 301 executes the background correction process illustrated in the flowchart of FIG. 14. In a case of accepting “None,” the CPU 301 executes no background correction process.

Note that in a case of accepting display of a preview image in the image region 1304, the CPU 301 displays the result of the background correction process as the preview image in the image region 1304. That is, the CPU 301 performs control to display a preview image corresponding to the selected correction mode. In this way, the user can save the read image subjected to the background correction process corresponding to an appropriate correction mode while checking the result of the background correction process.

The CPU 301 implements the series of processes illustrated in the flowchart of FIG. 14 (background correction process) by loading a program stored in the ROM 302 to the RAM 303 and executing it. In the background correction process illustrated in the flowchart of FIG. 14, the process of S1102 illustrated in the flowchart of FIG. 11 is replaced with the process of S1402.

In S1402, the CPU 301 causes the image processing unit 304 to execute a pixel correction process. Specifically, the CPU 301 transmits the read image obtained in S1101 and the strength (threshold value) designated in the strength adjustment item 1302 to the image processing unit 304 along with a correction request. In response to accepting the read image and the strength (threshold value) along with this correction request, the image processing unit 304 executes a pixel correction process. This pixel correction process is a process of comparing each pixel in the read image with the strength (threshold value) designated in the strength adjustment item 1302, and correcting the pixel values of pixels at or above the strength (threshold value) in accordance with a lookup table. In the case where this background correction process is executed, then in S1103, the CPU 301 obtains the result of the pixel correction process from the image processing unit 304 as a corrected image.

As described above, the CPU 301 is capable of switching between using a machine learning model to correct the pixel values of the background portion and using a rule base to correct the pixel values of the background portion in accordance with the user's operation.

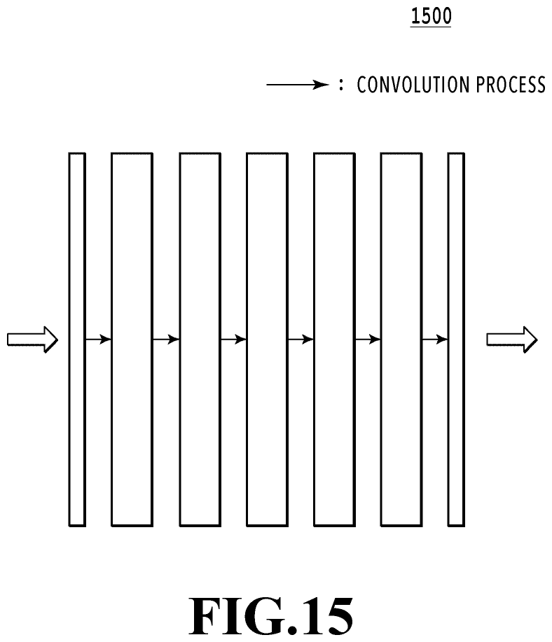

Also, in the present embodiment, the machine learning model 500 is used as one image generation model, but the image generation model is not limited to the machine learning model 500. FIG. 15 is a diagram illustrating an example of a machine learning model 1500 as another image generation model. This machine learning model 1500 is also a CNN model. The machine learning model 1500 includes neither an upsampling process nor a skip connection process and is formed of six convolution process layers. This machine learning model 1500 may be used as one CNN model in place of the machine learning model 500 or in addition to the machine learning model 500.

In a CNN model, the range that can be referenced for a target pixel is determined by the size of the convolution process, the number of layers, and the scaling process. For example, as long as the resolution is high and the background portion and the printed portions are identifiable from local features, high-speed processing may be achieved by using a simple CNN model, such as the machine learning model 1500. Also, neutral networks other than CNNs, such as transformers or fully connected networks, may also be used as machine learning models.

Also, in the present embodiment, the learning process is performed to make the output image close to the correct image, but is not limited to this. For example, the learning process may be performed to make the input image close to the correct image. This reduces patterns in the output image, allowing for background correction with less model parameters. Also, in the present embodiment, neither the training data nor the corrected data is classified by printing resolution, quantized pattern, or the like but may be classified by printing resolution, quantized pattern, or the like.

### Second Embodiment

In the first embodiment, a case in which an image generation model is used as a machine learning model has been exemplarily described. In a second embodiment, a case in which a classification model is used as a machine learning model will be exemplarily described. In the following, description of contents common to the first embodiment will be omitted as appropriate, and the difference will be mainly described.

### <Machine Learning>

In the present embodiment, a classification model that performs classification into a plurality of classification labels is used. The classification model is a machine learning model that outputs the probability of each of a plurality of classification labels. A classification label is information (identifier) indicating to which classification the input data belongs.

### <<Machine Learning Model>>

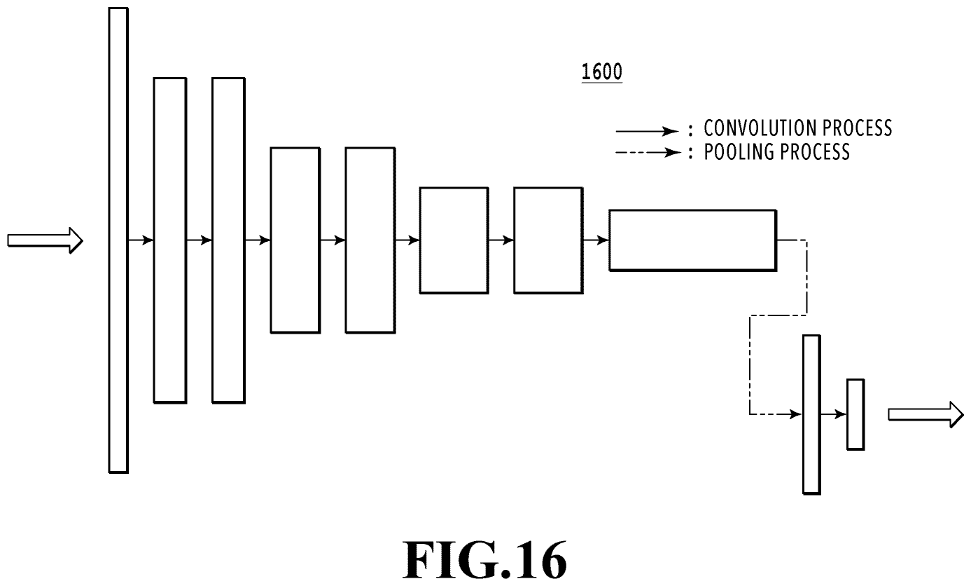

FIG. 16 is a diagram illustrating an example of a machine learning model 1600 as a classification model. In the example of FIG. 16, image data is illustrated similarly to the example of FIG. 5. Also, in the example of FIG. 16, each solid arrow represents a convolution process, as in the example of FIG. 5. Also, the long dashed double-short dashed arrow represents a pooling process. The pooling process is performed to extract features. Specifically, it is a process that calculates the largest value or an average value for each of a plurality of regions in input data, and obtains data to be output from the calculation result. In a case of calculating the largest value, the pooling process is also called max pooling, for example. In a case of calculating an average value, the pooling process is also called average pooling, for example.

The data output from the machine learning model 1600 is data indicating the result of classifying an appropriate degree of correction strength for a rule-based pixel correction process. This data is obtained as the result of the pooling process, and is a one-dimensional vector with the same length as the number of channels in the data immediately before the pooling process.

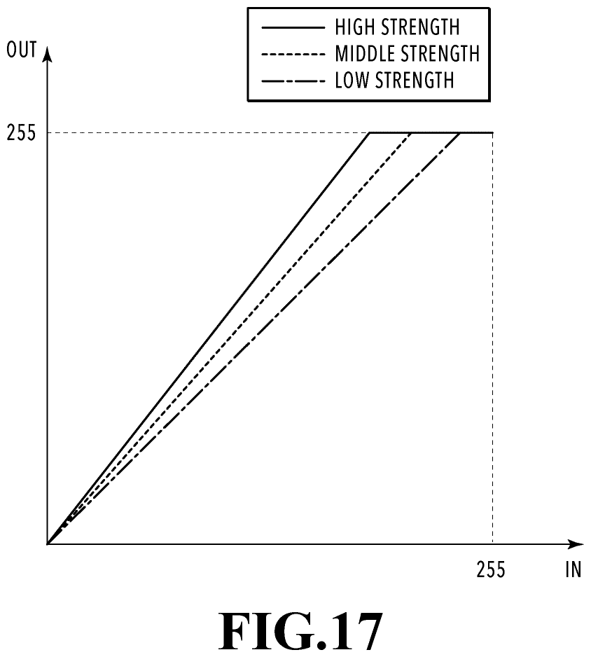

In the present embodiment, a 1D-LUT is individually associated with each of three levels of strength. The 1D-LUT means a one-dimensional lookup table. FIG. 17 is a diagram illustrating an example of the 1D-LUT. In the example of FIG. 17, a first table, a second table, and a third table are illustrated. The first table is a 1D-LUT associated with “HIGH STRENGTH.” The second table is a 1D-LUT associated with “MIDDLE STRENGTH” lower than “HIGH STRENGTH.” The third table is a 1D-LUT associated with “LOW STRENGTH” lower than “MIDDLE STRENGTH.”

The machine learning model 1600 outputs three-dimensional data corresponding to each of the three levels of strength to which the above-described 1D-LUTs are associated. Specifically, each of the elements forming the three dimensions has a value ranging from 0 to 1, and an output result in which the total of these is 1 is obtained. This output result is obtained by the softmax function or the like.

### <<Learning Process>>

In the present embodiment, the learning process illustrated in the flowchart of FIG. 8 is executed, but the data used in the learning process is different from that in the first embodiment. Specifically, in the first embodiment, the training data loaded in S802 includes a training pair including an input image and a correct image. In the present embodiment, on the other hand, the training data loaded in S802 includes a training pair including an input image and a classification label indicating a correct answer. Note that, in the present embodiment, the correct image in the first embodiment is replaced with the classification label, and thus the second text box 702 for the training data illustrated in FIG. 7 is changed as well. Specifically, in the present embodiment, the second text box 702 is a text box for setting a path to a folder storing classification labels indicating the correct answer.

Also, in the first embodiment, the result of the process executed by the machine learning model in S804 or S808 is an output image. In the present embodiment, on the other hand, the result of the process executed by the machine learning model in S804 or S808 is a probability. Specifically, the probability of one of the elements forming the above-described dimensions is obtained as the result of the process executed by the machine learning model.

Also, in the first embodiment, the mean squared error is used as the loss function for the process of S805. In the present embodiment, on the other hand, a cross-entropy function is used as the loss function for the process of S805. Cross-entropy functions tend to be used for classification models.

Also, in the first embodiment, the verification data loaded in S807 includes a verification pair including an input image and a correct image. In the present embodiment, on the other hand, the verification data loaded in S807 includes a verification pair including an input image and a classification label. Note that, in the present embodiment, the correct image in the first embodiment is replaced with the classification label, and thus the fourth text box 704 for the verification data illustrated in FIG. 7 is changed as well. Specifically, in the present embodiment, the fourth text box 704 is a text box for setting a path to a folder storing classification labels to be used for accuracy verification in the learning.

Also, in the first embodiment, the output image obtained in S808 and the correct image paired with the input image input into the machine learning model in S808 are used in the calculation of the evaluation value in S809. In the present embodiment, the probability obtained in S808 and the probability paired with the input image input into the machine learning model in S808 are used in the calculation of the evaluation value in S809.

### <<Training Data Creation Screen>>

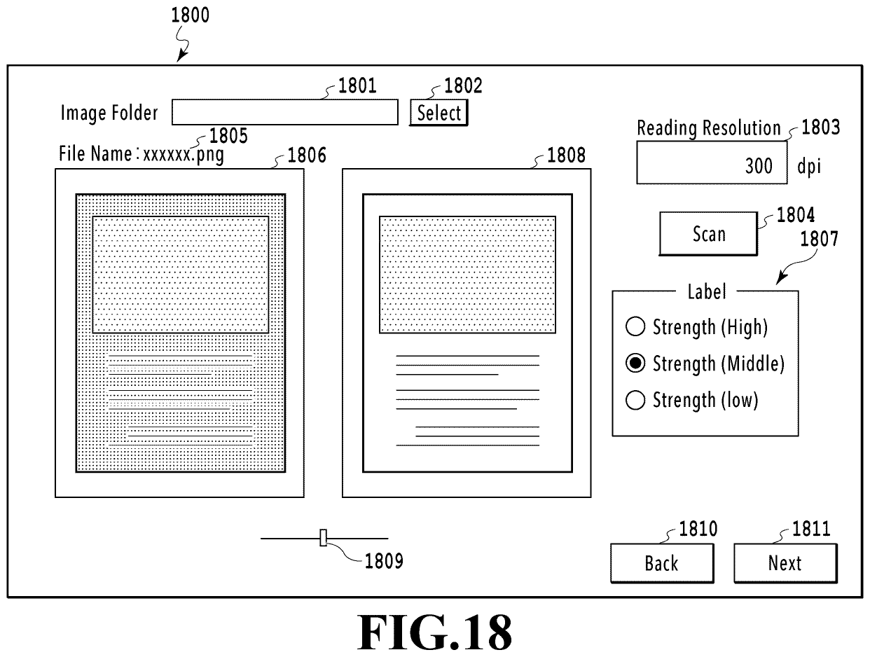

FIG. 18 is a diagram illustrating an example of a training data creation screen 1800 in the second embodiment. The training data creation screen 1800 is a screen for creating training data. This training data creation screen 1800 is displayed by the learning apparatus 310.

For example, in response to receiving an instruction to launch an executable file, the learning apparatus 310 displays the training data creation screen 1800, which is a user interface, on the display included in the learning apparatus 310. The executable file is stored in a storage device accessible by the learning apparatus 310. Note that the executable file is not limited to one which directly displays the training data creation screen 1800 in response to being launched. For example, an executable file may be employed which displays a launcher screen in response to being launched, and displays the training data creation screen 1800 in a case where an item for creating training data provided in that launcher screen is selected. This makes it possible to switch between the learning setting screen 700 and the training data creation screen 1800.

The training data creation screen 1800 is provided with a path box 1801 and a select button 1802. The path box 1801 is a text box for designating a folder path for image data to be labeled. The image data to be labeled means image data to which to attach classification label indicating the correct answer. The select button 1802 is a button for selecting the image data to be labeled. In a case where the user presses the select button 1802, a selection dialogue is displayed on the display, and the user selects (designates) a folder in the selection dialogue, in response to which the folder path to that folder is set in the path box 1801.

Also, the training data creation screen 1800 is provided with a resolution box 1803, a scan button 1804, an image file name 1805, and an image region 1806. The resolution box 1803 is a text box for designating a reading resolution at which the reading apparatus 100 reads a printed product. The scan button 1804 is an operation part for the reading apparatus 100 to accept starting of reading of the printed product. In a case where the scan button 1804 is pressed, the reading apparatus 100 accepts starting of reading of the printed product. In this case, the reading apparatus 100 reads the printed product at the reading resolution designated in the resolution box 1803. Image data of the printed product read by the reading apparatus 100 is saved to the folder designated in the path box 1801. Also, the file name of the image data of the printed product read by the reading apparatus 100 is displayed as the image file name 1805. Also, the image of the image data of the printed product read by the reading apparatus 100 is displayed in the image region 1806.

Also, the training data creation screen 1800 is provided with a label item 1807. The label item 1807 is an operation part for designating a classification label indicating the correct answer. Specifically, the label item 1807 is an operation part for designating the strength of correction on the pixel values of the background portion of the image displayed in the image region 1806. In the example of FIG. 18, radio buttons corresponding to respective levels of strength are provided. The user may press one of the radio buttons corresponding to the levels of strength to designate a desired strength. The designated radio button becomes turned on, while the undesignated radio buttons are turned off.

Also, the training data creation screen 1800 is provided with a preview region 1808 and a zoom bar 1809. A preview image is displayed in the preview region 1808. This preview image is the result of performing a pixel correction process on the image displayed in the image region 1806 with the strength designated in the label item 1807. Note that the pixel correction process in the present embodiment is a process of comparing each pixel in the image with a threshold value and correcting the pixel values of pixels greater than or equal to the threshold value in accordance with a 1D-LUT corresponding to the strength designated in the label item 1807. The zoom bar 1809 is an operation part (slide bar) for simultaneously zooming the images displayed in the image region 1806 and the preview region 1808.

Also, the training data creation screen 1800 is provided with a back button 1810 and a next button 1811. The back button 1810 is an operation part for accepting an operation to bring the setting contents on the training data creation screen 1800 back to the last setting contents. The next button 1811 is an operation part for accepting an operation to proceed to next setting contents on the training data creation screen 1800.

### <<Training Data Creation Process>>

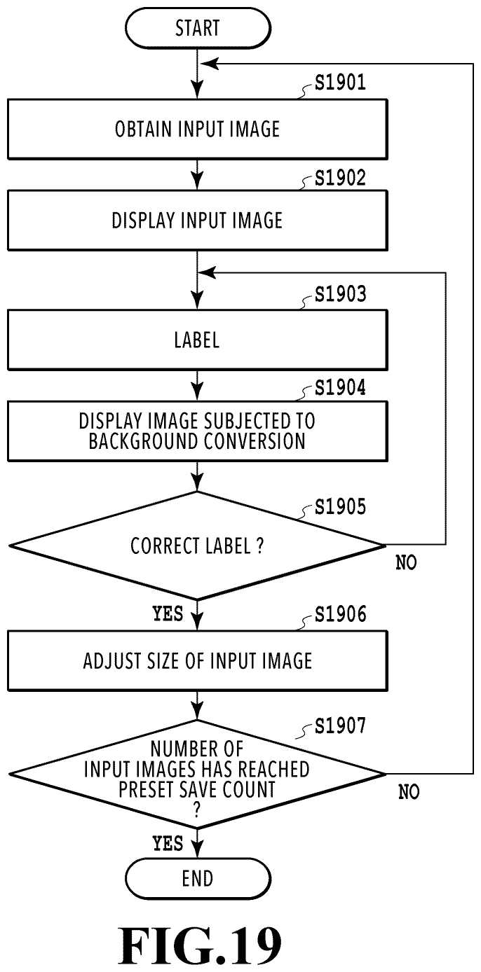

FIG. 19 is a flowchart illustrating an example of a training data creation process in the second embodiment. The series of processes illustrated in the flowchart of FIG. 19 (training data creation process) is executed in the present embodiment. In the present embodiment, in response to a press on the scan button 1804, the learning apparatus 310 accepts a training data creation instruction and starts the training data creation process.

In S1901, the learning apparatus 310 obtains an input image. Specifically, the learning apparatus 310 requests the reading apparatus 100 to perform reading at the reading resolution designated in the resolution box 1803. In response to accepting the reading request from the learning apparatus 310, the reading apparatus 100 generates an image with the designated reading resolution and transmits it to the learning apparatus 310. The learning apparatus 310 obtains the image transmitted as a response to the reading request from the reading apparatus 100 as an input image to be used in a learning process and saves it to the folder designated in the path box 1801. After obtaining the input image, the learning apparatus 310 advances the process to S1902.

In S1902, the learning apparatus 310 displays the input image obtained in S1901 in the image region 1806, and displays the file name of the obtained input image as the image file name 1805. Then, the learning apparatus 310 advances the process to S1903.

In S1903, the learning apparatus 310 performs labeling. Specifically, in response to the user designating a classification label in the label item 1807, the learning apparatus 310 associates the designated classification label with the input image obtained in S1901. Note that, in a case where a classification label is not designated for the input image within a predetermined time after the input image is obtained in S1901, the learning apparatus 310 may display a message that prompts the user to designate a classification label or the like. After saving the classification label, the learning apparatus 310 advances the process to S1904.

In S1904, the learning apparatus 310 displays an image subjected to background conversion. Specifically, the learning apparatus 310 performs a pixel correction process on the input image obtained in S1901 using the 1D-LUT corresponding to the strength designated in the label item 1807. Also, the learning apparatus 310 displays the image obtained as the result of the pixel correction process in the preview region 1808 as a preview image. After displaying the image subjected to the background conversion, the learning apparatus 310 advances the process to S1905.

In S1905, the learning apparatus 310 judges whether the accepted labeling instruction was correct. Specifically, the user refers to the preview image displayed in the preview region 1808 and judges whether the background portion has been properly corrected. Here, if judging that the background portion has not been properly corrected, the user changes the strength designated in the label item 1807. In this case, the learning apparatus 310 returns the process to S1903. On the other hand, if judging that the background portion has been properly corrected, the user presses the next button 1811. In this case, the learning apparatus 310 advances the process to S1906.

In S1906, the learning apparatus 310 adjusts the image size of the input image. This is because the classification models are designed and expected to receive images of a specific image size. After adjusting the image size of the input image to the specific image size, the learning apparatus 310 stores the input image obtained in S1901 and the classification label representing a correct answer indicating that correct labeling has been done as a training pair in a predesignated storage location, and advances the process to S1907.

In S1907, the learning apparatus 310 checks whether the number of input image has reached a preset save count. The preset save count is the number of images to be saved in the folder designated in the path box 1801. The preset save count may be fixed or designated by the user's operation. The learning apparatus 310 returns to S1901 if the number of input images has not reached the preset save count, and terminates the training data creation process if the number of input images has reached the preset save count. Note that, before terminating the training data creation process, the learning apparatus 310 may display a message for notifying that the labeling of input images of the preset save count has been finished.

### <Background Correction Process>

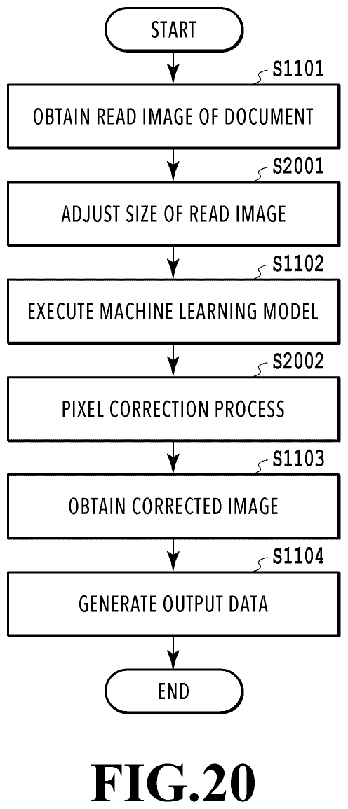

FIG. 20 is a flowchart illustrating an example of the background correction process in the present embodiment. In the background correction process in the present embodiment, the process of S2001 is added between S1101 and S1102 illustrated in the flowchart of FIG. 11. Also, in the background correction process in the present embodiment, the process of S2002 is added between S1102 and S1103 illustrated in the flowchart of FIG. 11.

In S2001, the CPU 301 causes the image processing unit 304 to execute a size adjustment process of adjusting the read image obtained in S1101 to a specific image size. Also, the CPU 301 obtains the read image subjected to the size adjustment process from the image processing unit 304 and then proceeds to S1102. In the present embodiment, the result of the process executed by a machine learning model in S1102 is a set of probabilities indicating which of the three levels of strength is suitable as the correction strength for the read image of the document obtained in S1101. Specifically, the probabilities of the classification labels representing “HIGH STRENGTH,” “MIDDLE STRENGTH,” and “LOW STRENGTH” are output.

In S2002, the CPU 301 performs a pixel correction process. Specifically, the CPU 301 obtains the probabilities transmitted from the learning apparatus 310 and then causes the image processing unit 304 to execute a pixel correction process. In this case, the CPU 301 transmits the classification label representing the highest probability among the probabilities obtained in S1103 and the read image obtained in S2001 to the image processing unit 304 along with a correction request. In response to accepting the classification label and the read image along with the correction request, the image processing unit 304 performs a pixel correction process on the read image. This pixel correction process is a process of comparing each pixel in the read image with a threshold value and converting pixel values greater than or equal to the threshold value using a table (1D-LUT) corresponding to the classification label with the highest probability. The image processing unit 304 supplies the read image subjected to the pixel correction process as a response to the correction request to the CPU 301. In S1103, the CPU 301 obtains the read image subjected to the pixel correction process as a corrected image.

As described above, according to the present embodiment, it is possible to appropriately correct an image, as in the first embodiment. For example, the CPU 301 of the reading apparatus 100 performs a pixel correction process on a read image using the probability of each of a plurality of classification labels output from a classification model. The plurality of classification labels include a plurality of strength labels being classification labels each of which classifies the strength of correction to be performed in the pixel correction process. The pixel correction process is a process of comparing each pixel in the read image with a threshold value and correcting the pixel values of pixels greater than or equal to the threshold value at the strength corresponding to the strength label with the highest probability. In this way, it is possible to perform correction that is suitable for the contents of the background portion and the printed portions of the read image. Accordingly, even in a case where varying shadows are formed on the document surface and/or the densities of dots formed on the document surface vary, it is possible to appropriately correct the color of the background portion while maintaining the colors of the printed portions. Also, by performing rule-based correction, the instability causing unexpected outputs from the machine learning model can be mitigated. That is, performing rule-based correction is advantageous as it prevents severe image degradation in a case where the estimation by the CNN model is not favorable.

Note that in the present embodiment, classification is performed with three 1D-LUTs differing from one another in a predetermined value, but the present disclosure is not limited to this. For example, classification may be performed with 3D-LUTs each of which determines an output value from each of R, G, and B pixel values. Alternatively, the classification with 1D-LUTs may include a simple thresholding process. This allows for finer classification.

Also, in the present embodiment, the background correction process, the learning process, and the estimation process are each performed on the entire image, but the image may be divided into a plurality of regions and the processes may be performed on each of the regions. In that case, the learning process is performed for each of the plurality of regions, and the sets of learned parameters corresponding to the respective regions are stored in the ROM 302. The reading apparatus 100 causes a machine learning model to execute a process using the learned parameters corresponding to a selected region. In this way, the more specific background correction can be performed.

### Third Embodiment

In the first embodiment, a case in which an image is input into a machine learning model has been described as an example. In the present embodiment, a case in which document-related information is input in addition to an image will be described as an example. The document-related information is information related to a document. In the following, description of contents common to the first embodiment will be omitted as appropriate, and the difference will be mainly described.

### <Machine Learning>

### <<Machine Learning Model>>

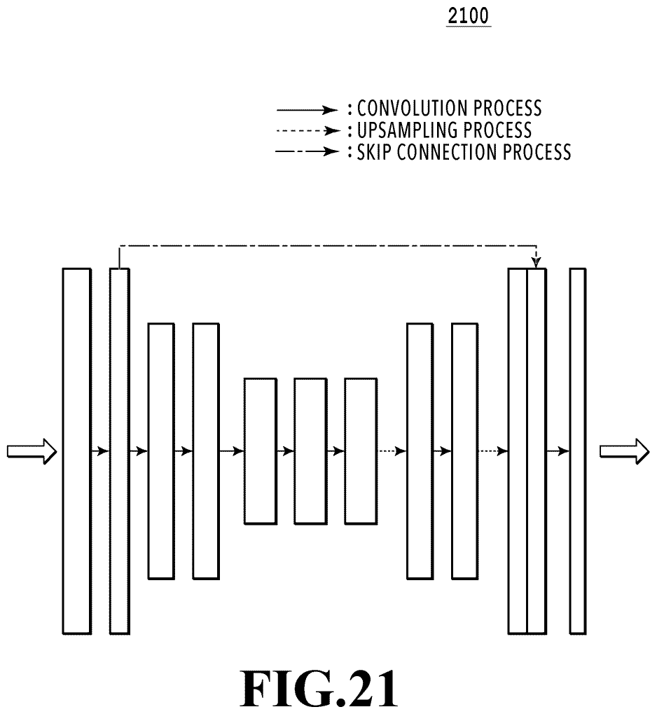

FIG. 21 is a diagram illustrating an example of a machine learning model 2100 used in the third embodiment. The structure of the machine learning model 2100 has eight convolution process layers, two upsamplings, and one skip connection.

In the example of FIG. 21, image data is illustrated similarly to the example of FIG. 5. Also, in the example of FIG. 21, convolution processes, upsamplings, and a skip connection are illustrated similarly to the example of FIG. 5.

Data with seven channels is input into the machine learning model 2100. The data with seven channels is image data with three R, G, and B channels representing an input image and data with four channels representing document-related information. The document-related information in the present embodiment includes four items, namely, paper type information indicating the paper type of the document, color mode information indicating monochrome or color, resolution information indicating the reading resolution, and printing type information indicating the printing type, but the number of items in the document-related information and their contents are not limited to these. Note that the output of the machine learning model 2100 is data with three R, G, and B channels, as in the example of FIG. 5.

### <<Training Data Creation Screen>>

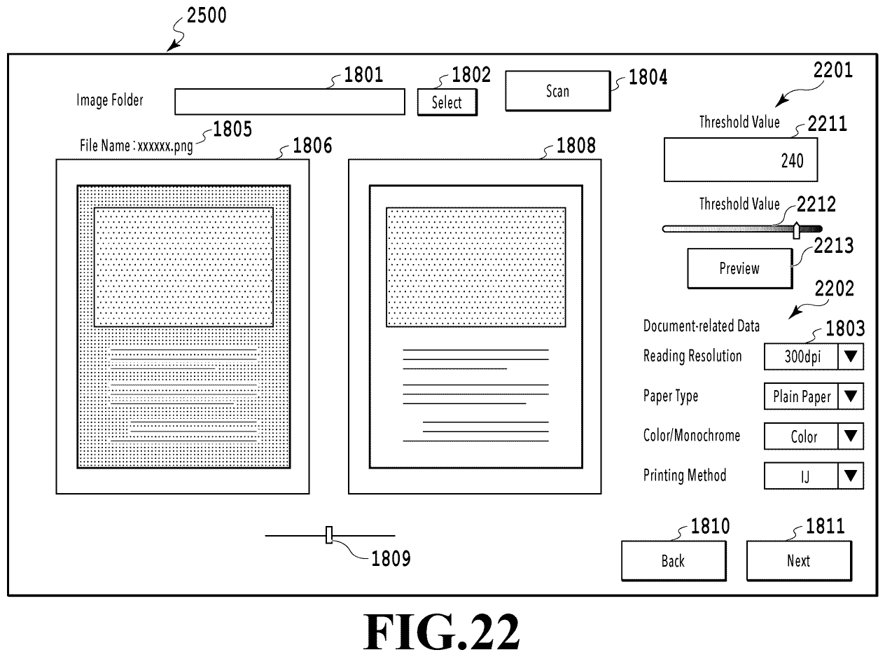

FIG. 22 is a diagram illustrating an example of a training data creation screen 2200 in the third embodiment. The training data creation screen 2200 is displayed by the learning apparatus 310, as with the training data creation screen 1800 in FIG. 18.

The training data creation screen 2200 is provided with a threshold value item 2201 and a document-related item 2202 in place of the label item 1807 provided to the training data creation screen 1800 in FIG. 18.

The threshold value item 2201 is an operation part for designating a threshold value to be used for a pixel correction process which is to be performed on the image displayed in the image region 1806. In the example of FIG. 22, a threshold value setting box 2211, a threshold value setting bar 2212, and a preview button 2213 are displayed in the threshold value item 2201.

The threshold value setting box 2211 is a text box into which a threshold value can be input. The threshold value setting bar 2212 is a bar representing a range within which to adjust the threshold value. The threshold value setting bar 2212 is provided with an indicator that is movable on the threshold value setting bar 2212. The threshold value becomes smaller as the indicator gets closer to one end of the threshold value setting bar 2212. Conversely, the threshold value becomes larger as the indicator gets closer to the other end of the threshold value setting bar 2212. The user may input a threshold value into the threshold value setting box 2211 or shift the position of the indicator on the threshold value setting bar 2212 to designate a desired threshold value. Note that the threshold value input in the threshold value setting box 2211 may be synchronized with the position of the indicator on the threshold value setting bar 2212.

The preview button 2213 is an operation part for accepting displaying of a preview image. Pressing the preview button 2213 displays a preview image in the preview region 1808. This preview image is the result of performing a pixel correction process on the image displayed in the preview region 1808 with the threshold value designated in the threshold value setting box 2211 or on the threshold value setting bar 2212. This pixel correction process is a process of comparing each pixel in the image with the threshold value designated in the threshold value setting box 2211 or on the threshold value setting bar 2212 and converting pixel values greater than or equal to the threshold value in accordance with a lookup table.

The document-related item 2202 is an operation part for designating the document-related information of the image displayed in the image region 1806. In the example of FIG. 22, a resolution box, a paper type box, a color mode box, and a printing type box are displayed. The resolution box is a text box for designating the reading resolution. The paper type box is a text box for designating the paper type of the document. The color mode box is a text box for designating monochrome or color. The printing type box is a text box for designating the printing type. The user can designate the reading resolution, the paper type of the document, the color mode, and the printing method in the corresponding text boxes as the document-related information of the image displayed in the image region 1806.

### <<Training Data Creation Process>>

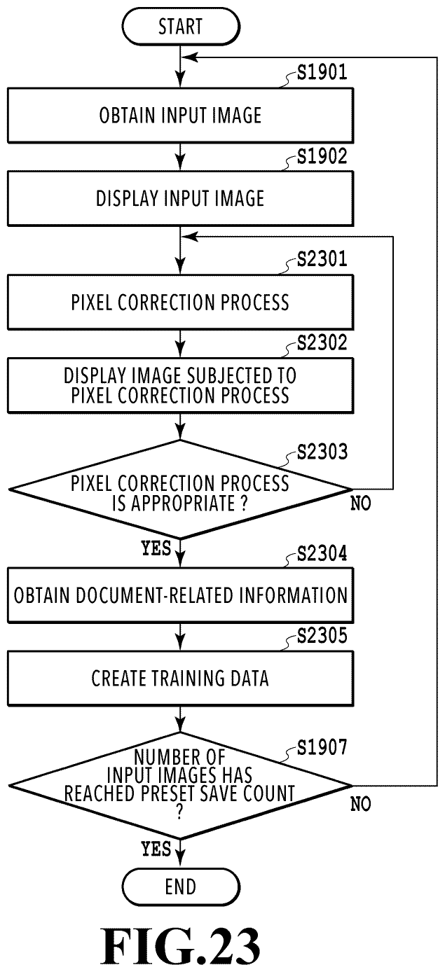

FIG. 23 is a flowchart illustrating an example of a training data creation process in the third embodiment. In the training data creation process in the present embodiment, the processes of S1903 to S1906 illustrated in the flowchart of FIG. 19 are replaced with the processes of S2301 to S2305.

In S2301, the learning apparatus 310 performs a pixel correction process. This pixel correction process is a process of comparing each pixel in the input image obtained in S1901 with the threshold value designated in the threshold value item 2201 and correcting the pixel values of pixels greater than or equal to the threshold value using a lookup table. After finishing the pixel correction process, the learning apparatus 310 displays the image subjected to the pixel correction process in the preview region 1808 as a preview image in the next step S2302. After displaying the image subjected to the pixel correction process, the learning apparatus 310 advances the process to S2303.

In S2303, the learning apparatus 310 judges whether it has accepted an instruction indicating that the pixel correction process was appropriate. Specifically, the user refers to the preview image displayed in the preview region 1808 and judges whether the background portion has been properly corrected. Here, if judging that the background portion has not been properly corrected, the user changes the threshold value designated in the threshold value item 2201. In this case, the learning apparatus 310 returns the process to S2301. On the other hand, if judging that the background portion has been properly corrected, the user presses the next button 1811. In this case, the learning apparatus 310 advances the process to S2304.

In S2304, the learning apparatus 310 obtains the pieces of document-related information designated in the document-related item 2202. Note that in a case where no document-related information is designated in the document-related item 2202, the learning apparatus 310 may display a message that prompts the user to designate document-related information or the like. Alternatively, the learning apparatus 310 may obtain default document-related information as the document-related information designated in the document-related item 2202. The default document-related information may be the document-related information designated last. After obtaining the document-related information, the learning apparatus 310 advances the process to S2305.

In S2305, the learning apparatus 310 creates training data. Specifically, the learning apparatus 310 modifies each piece of document-related information obtained in S2304 into data with the same height and width as those of the input image obtained in S1901 (document-related data). The resulting pixels store values corresponding to the pieces of document-related information designated in the document-related item 2202. For example, in a case where monochrome is designated in the color mode box, a pixel value of 255 is set. Alternatively, in a case where color is designated in the color mode box, a pixel value of 0 is set. The learning apparatus 310 generates input data using the modified pieces of document-related data and the input image obtained in S1901. After generating the input data, the learning apparatus 310 stores the image subjected to the pixel correction process in S2301 (correct image) and the input data as a training pair in a predesignated storage location, and advances the process to S1907.

### <Background Correction Process>

In the present embodiment, the reading apparatus 100 is capable of switching between using a machine learning model to correct the pixel values of the background portion and using a rule base to correct the pixel values of the background portion. For example, the CPU 301 of the reading apparatus 100 displays the menu screen (not illustrated) on a display of an information terminal connected thereto through the data communication unit 308. In a case where the reading apparatus 100 includes the display 1201, the CPU 301 may display the menu screen on the display 1201.

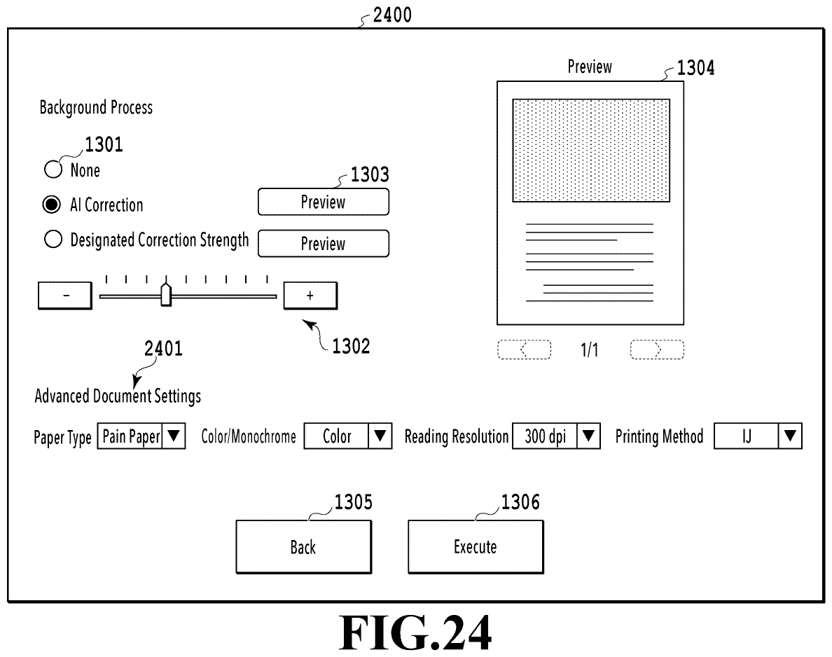

The CPU 301 displays a setting screen in a case where a setting item for a background process is selected from among setting items on the menu screen displayed on the display. FIG. 24 is a diagram illustrating an example of a setting screen 2400 in the third embodiment. The setting screen 2400 is provided with a document-related item 2401 in addition to the elements of the setting screen 1300 illustrated in FIG. 13. The document-related item 2401 is similar to the document-related item 2202 in FIG. 22.

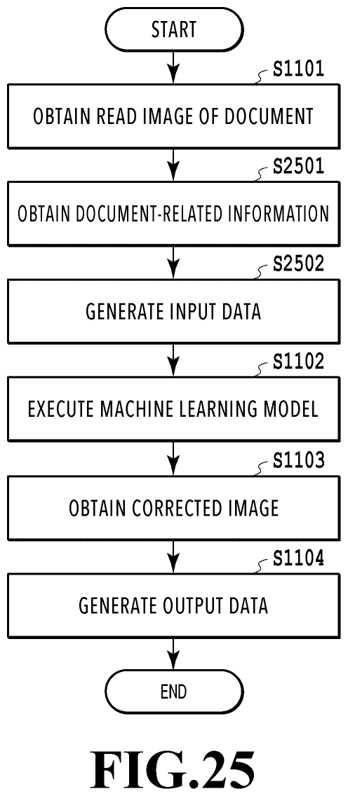

In a case of accepting “AI Correction,” the CPU 301 executes the background correction process illustrated in the flowchart of FIG. 25. FIG. 25 is a flowchart illustrating an example of the background correction process in the third embodiment. In the background correction process in the present embodiment, the processes of S2501 and S2502 are added between S1101 and S1102 illustrated in the flowchart of FIG. 11.

In S2501, the CPU 301 obtains the pieces of document-related information designated in the document-related item 2401. Then, in S2502, the CPU 301 generates input data to be input into a machine learning model based on the obtained pieces of document-related information. This generation of input data is similar to the generation of input data in S2305 described above.

As described above, according to the present embodiment, it is possible to appropriately correct an image, as in the first embodiment. For example, the CPU 301 of the reading apparatus 100 obtains document-related information being information related to a document and causes a machine learning model to execute a process by inputting a read image of the document and the document-related information thereinto. In this way, the amount of information is larger than in a case where the document-related information is not input into the machine learning model. This makes it possible to obtain, for example, an image in which the colors represented by the pixel values of the background portion are corrected taking into account not only the information formed on the document surface but also regularity with the document-related information. Therefore, it is possible to appropriately correct the color of the background portion while maintaining the colors of the printed portions.

Note that in the present embodiment, document-related information is used as a part of the input into a machine learning model, but the present disclosure is not limited to this. The document-related information may be used to switch the correction mode. For example, based on the document-related information, the CPU 301 may select the correction mode that uses a machine learning model to correct the colors (pixel values) of the pixels of the background portion or the correction mode which uses a rule base to correct the colors (pixel values) of the pixels of the background portion. This can limit the conditions for read images to be handled by one machine learning model, making it possible to execute an accurate background correction process with a lightweight machine learning model. Also, even a user with limited knowledge on background correction can perform appropriate correction.

Also, in the present embodiment, document-related information is input into a machine learning model along with an image, but the present disclosure is not limited to this. For example, after an image is input into a machine learning model, the document-related information may be input into an output from the machine learning model at an intermediate stage. In other words, the position at which the document-related information is input into a machine learning model may be different from the position at which an image is input into the machine learning model. This eliminates the need to input document-related information with the same size as an image, which has a large amount of data, into a machine learning model. In this way, the amount of calculation is reduced, allowing for a high-speed background correction process.

### Other Embodiments

The present disclosure is not limited to the above-described embodiments.

For example, the background correction process may be performed using the result of classifying for each pixel whether it is in the background portion or in a printed portion. In this case, a model (image generation model) that outputs an image on a pixel-by-pixel basis is used as the machine learning model. Thus, the learning phase is similar to that in the first embodiment. As the background correction process, the background correction process illustrated in the flowchart of FIG. 20 may be used, but the contents of some processes are different. Specifically, each pixel in the read image is output as the result of the process by a machine learning model in S1102. For this reason, the CPU 301 advances the process to S2002 without executing the process of S2001. In S2002, the CPU 301 performs a process of not correcting the colors of the pixels with pixel values less than a preset value and correcting the colors of the pixels with pixel values greater than or equal to the preset value as the pixel correction process and obtains the corrected image. In this way, it is possible to appropriately correct the color of the background portion while maintaining the colors of the printed portions.

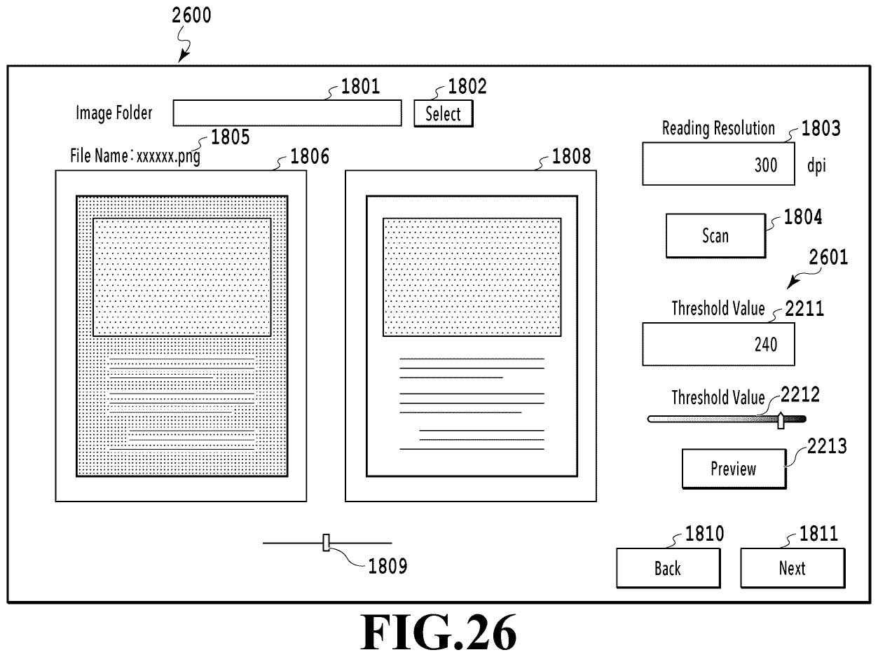

Also, as the machine learning model, a model (classification model) that outputs a specific value to be used in a process of correcting the pixel values of the background portion with a rule base (pixel correction process) may be used. The machine learning model 1600, for example, may be employed as this model. The data output from the model that outputs the specific value is one-dimensional data. The specific value is, for example, a threshold value to be compared with each pixel value of the image in the pixel correction process. FIG. 26 is a diagram illustrating an example of a training data creation screen 2600 in a case of using a classification model that classifies the threshold value. The training data creation screen 2600 is provided with a threshold value item 2601 in place of the label item 1807 in the training data creation screen 1800 in FIG. 18. This threshold value item 2601 is similar to the threshold value item 2201 in FIG. 22.

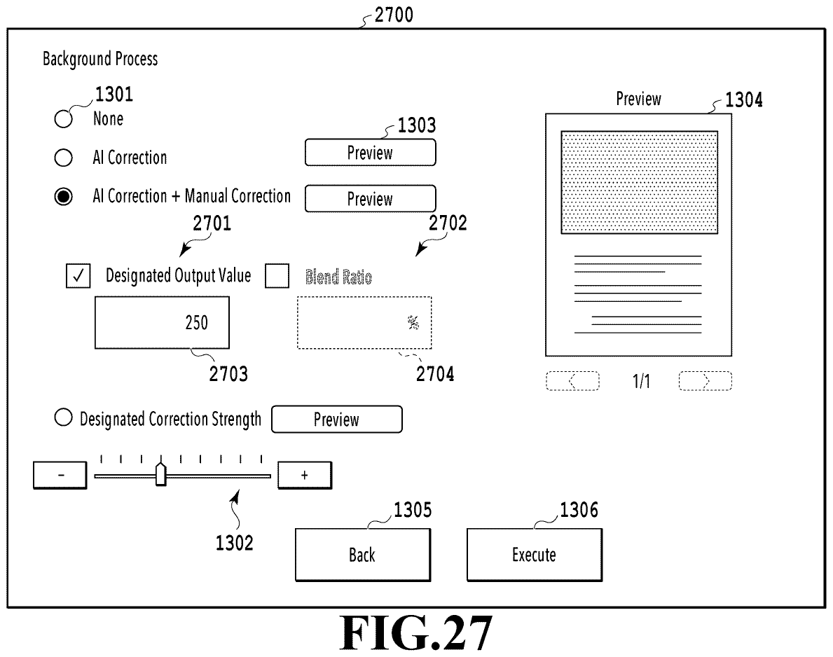

In a case of using the classification model that classifies the threshold value, the reading apparatus 100 can switch the model from the image generation model in the first embodiment. For example, the CPU 301 of the reading apparatus 100 displays the menu screen (not illustrated) on a display of an information terminal connected thereto through the data communication unit 308. In a case where the reading apparatus 100 includes the display 1201, the CPU 301 may display the menu screen on the display 1201. The CPU 301 displays a setting screen in a case where a setting item for a background process is selected from among setting items on the menu screen displayed on the display. FIG. 27 is a diagram illustrating an example of a setting screen 2700 in another embodiment. The setting screen 2700 is provided with “AI Correction+Manual Correction” in place of “Designated Correction Strength” in the setting screen 2400 in FIG. 24. Also, the setting screen 2700 is provided with an output value designation item 2701 and a blend ratio item 2702 in place of the document-related item 2401 in the setting screen 2400.

The output value designation item 2701 is an operation part for designating the output value (threshold value) to be output from the model. The output value designation item 2701 is provided with an output value box 2703 into which a value can be input. The blend ratio item 2702 is an operation part for designating the ratio between the maximum value to which a pixel value can be converted and the output value. In a case where a pixel is expressed on a 256-level scale, the maximum value to which its pixel value can be converted is 255. The blend ratio item 2702 is provided with a blend ratio box 2704 into which a value can be input.

Either the output value designation item 2701 or the blend ratio item 2702 can be operated in a case where “AI Correction+Manual Correction” is selected. In the example of FIG. 27, a checkbox is provided for each of the output value designation item 2701 and the blend ratio item 2702. The user may select a desired item by checking the corresponding checkbox and input a value into the selected item's box to designate the output value or the ratio.

In a case of accepting “AI Correction,” the learned parameters of an image generation model stored in the ROM 302 will be used. In this case, the CPU 301 executes the background correction process illustrated in the flowchart of FIG. 11. In a case of accepting “AI Correction+Manual Correction,” the CPU 301 will use the learned parameters of a classification model stored in the ROM 302. In this case, the CPU 301 executes the background correction process illustrated in the flowchart of FIG. 20 in which the contents of some processes are different. Specifically, the result of the process of S1102 is one-dimensional data that outputs a specific value. Thus, the pixel correction process executed in S2002 is a process of comparing each pixel in the read image with the specific value (threshold value) output from the model and converting pixel values greater than or equal to the threshold value using a 1D-LUT. The result of this pixel correction process is displayed in the image region 1304. This allows the user to adjust the specific value to be output from the model with the output value designation item 2701 or the blend ratio item 2702 while checking the result of the pixel correction process.

In the above-described embodiments, a first process being the background correction process in the first embodiment using an image generation model and a second process being the background correction process in the second embodiment using a classification model are separately performed, but the first process and the second process may be switchable. In this case, the learned parameters of the image generation model and the learned parameters of the classification model are stored in the ROM 302. Though not illustrated, in a case where a setting item for a background process is selected, the CPU 301 displays a setting screen having a first button for accepting the first process and a second button for accepting the second process on a display. In a case of accepting the first process, the CPU 301 executes the background correction process illustrated in the flowchart of FIG. 11. In a case of accepting the second process, the CPU 301 executes the background correction process illustrated in the flowchart of FIG. 20. Note that the CPU 301 may select between the first process and the second process based on document-related information.

Note that in the above-described embodiments, one image generation model and one classification model are included as learning correction modes being correction modes that use a machine learning model to correct the colors of the pixels of the background portion, but the present disclosure is not limited to these. For example, a plurality of image generation models with different model structures may be included. Alternatively, a plurality of classification models with different model structures may be included.

In the above-described embodiments, an update function to update the learned parameters to be used by a machine learning model or the threshold value to be used in a pixel correction process is not included, but the update function may be included. This update function is used in a case where the background correction process is not performed appropriately or in other similar cases. For example, the operation part 104 of the reading apparatus 100 is provided with an update button. In a case of accepting an update instruction in response to a press on the update button, the CPU 301 of the reading apparatus 100 reads the background (print medium) at a high resolution and updates the learned parameters to be used by a machine learning model or the threshold value to be used in a pixel correction process based on the read image. Note that before starting reading the background (print medium), the CPU 301 may notify of a message that prompts the user to perform reading of the print medium used in the background correction process which was not appropriately performed.

In the above-described embodiments, a background notification function is not included, but the background notification function may be included. The background notification function is a function to notify an information processing apparatus capable of communicating with the reading apparatus 100 of information indicating the background (print medium). For example, the operation part 104 of the reading apparatus 100 is provided with a notify button. In a case of accepting a notification instruction in response to a pressed on the notify button, the CPU 301 of the reading apparatus 100 notifies of a message that prompts the user to set the print medium used in the background correction process which was not appropriately performed on the document plate and start reading of the print medium. In a case of accepting an instruction to start a scan, the CPU 301 reads the print medium at a high resolution and transmits data of the read image to the information processing apparatus through the data communication unit 308.

In the above-described embodiments, the learning apparatus 310, which is external to the reading apparatus 100, is caused to execute a machine learning model's process, but the present disclosure is not limited to this. A machine learning model's process may be executed in the reading apparatus 100. For example, the image processing unit 304 causes a machine learning model to execute a process. In this case, the machine learning model may be stored in the ROM 302 or obtained from the learning apparatus 310.

In the above-described embodiments, CNN models are employed as machine learning models, but the present disclosure is not limited to this. For example, support vector machine (SVM) models may be employed as machine learning models. Alternatively, linear regression models may be employed as machine learning models. Alternatively, polynomial regression models may be employed as machine learning models. Note that the model parameters of the CNN models include a weight and a bias. The model parameters of the SVM models include a regularization parameter. The model parameters of the linear regression models include a slope and an intercept. The model parameters of the polynomial regression models include the coefficients of non-linear functions called basis functions. Note that the model parameters of the CNN models (image generation models or classification models) may include a model structure in addition to the weight and the bias. The model structure is information indicating the structure of the model such as the types and number of layers, as described earlier.

In the above-described embodiments, the CPU 301 of the reading apparatus 100 loads and obtains learned parameters stored in the ROM 302 in the reading apparatus 100, but the present disclosure is not limited to this. The CPU 301 of the reading apparatus 100 may load and obtain learned parameters stored outside the reading apparatus 100.

In the above-described embodiments, the reading apparatus 100 executes the background correction process, but the present disclosure is not limited to this. For example, an image processing apparatus connected to the reading apparatus 100 through a network or the like may execute the background correction process on the read image read by the reading apparatus 100. In this case, the image processing apparatus supplies the read image obtained by performing the background correction process to the reading apparatus 100.

In the above-described embodiments, a learning process is performed using images obtained by actual scanning or images obtained by simulated scanning, but the present disclosure is not limited to this. A learning process may be performed using both images obtained by actual scanning and images obtained by simulated scanning. Alternatively, a learning process may be performed using images obtained by simulated scanning, and then a learning process may additionally be performed using images obtained by actual scanning. This allows for efficient learning with a small amount of image data obtained by actual scanning.

Also, while the present disclosure has been described in detail based on its preferred embodiments, the present disclosure is not limited to these specific embodiments and encompasses various forms without departing from the gist of this disclosure. Further, each of the above embodiments is merely one embodiment of the present disclosure, and the embodiments can be combined as appropriate.

Also, the various processes described above as processes to be performed by the CPU 301 may be performed by a single piece of hardware, or the processes may be shared and performed by a plurality of pieces of hardware (e.g., a plurality of processors or circuits). For example, at least part of the CPU 301 that functions as the reading unit, model execution unit, obtaining unit, second obtaining unit, selection unit, and display control unit described below or the like may be configured of hardware.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to appropriately correct an image.

This application claims the benefit of Japanese Patent Application No. 2025-040255, filed Mar. 13, 2025, which is hereby incorporated by reference herein in its entirety.

What is claimed is:

1. A reading apparatus comprising:
one or more memories storing instructions; and
one or more processors which function as:
a reading unit configured to be capable of reading a document;
a model execution unit configured to cause a machine learning model to execute a process using a read image of the document obtained based on reading by the reading unit as an input, the machine learning model having been trained for correction of a background of a document surface by using a shape of the document surface; and
an obtaining unit configured to obtain a corrected image subjected to a pixel correction process using a result of the process executed by the model execution unit, the pixel correction process being a process of correcting a color of a pixel of a background portion in the read image of the document.

2. The reading apparatus according to claim 1, wherein the shape of the document surface includes at least one of varying shadows formed on the document surface and varying densities of dots printed on the document surface.

3. The reading apparatus according to claim 1, wherein the machine learning model has been trained for correction of the background of the document surface by using an input image which includes a printed portion and a background portion and in which pixel values of the background portion vary, and an image in which the varying pixel values of the background portion are corrected to be within a predetermined range.

4. The reading apparatus according to claim 1, wherein a reading resolution at which the reading unit performs reading is more than or equal to a resolution at which a pattern formed by dots printed on the document is readable.

5. The reading apparatus according to claim 1, further comprising a second obtaining unit configured to obtain document-related information being information related to the document, wherein
the model execution unit causes the machine learning model to perform a process using the read image of the document and the document-related information as an input, and
the machine learning model has been trained by further using the document-related information.

6. The reading apparatus according to claim 1, wherein the obtaining unit obtains, from among learned model parameters of the machine learning model associated respectively with a plurality of resolutions, the learned model parameter corresponding to a reading resolution at which the reading unit performs reading.

7. The reading apparatus according to claim 1, wherein
the machine learning model is an image generation model which generates an image by performing a calculation corresponding to the pixel correction process, and
the obtaining unit obtains the image output from the image generation model as the corrected image.

8. The reading apparatus according to claim 1, wherein
the machine learning model is a classification model, and
the obtaining unit performs the pixel correction process on the read image of the document using a value output from the classification model.

9. The reading apparatus according to claim 8, wherein
the output of the classification model is probabilities of a plurality of classification labels for classifying strength of correction to be performed in the pixel correction process, and
the pixel correction process is a process of comparing each pixel in the read image of the document with a threshold value and correcting a pixel value of the pixel greater than or equal to the threshold value at a strength corresponding to the classification label with the highest probability.

10. The reading apparatus according to claim 9, wherein the strength is a ratio of a change in a corrected pixel value to a change in an original pixel value.

11. The reading apparatus according to claim 8, wherein the pixel correction process is a process of comparing each pixel in the read image of the document with a value output from the classification model and correcting a pixel value of the pixel greater than or equal to the value using a lookup table.

12. The reading apparatus according to claim 1, wherein
the machine learning model is a model that outputs the read image of the document on a pixel-by-pixel basis, and
the obtaining unit obtains the corrected image by not correcting a color of the pixel whose value is less than a preset value and correcting a color of the pixel whose value is greater than or equal to the preset value.

13. The reading apparatus according to claim 1, further comprising a selection unit configured to select one of a plurality of correction modes, wherein
the obtaining unit obtains the corrected image corresponding to the correction mode selected by the selection unit.

14. The reading apparatus according to claim 13, wherein
the plurality of correction modes include a first correction mode being a correction mode that corrects a color of a pixel of the background portion using an image generation model and a second correction mode being a correction mode that corrects the color of the pixel of the background portion using a rule base,
in a case where the first correction mode is selected, the obtaining unit obtains an image output from the image generation model as the corrected image, and
in a case where the second correction mode is selected, the obtaining unit obtains the corrected image by executing the pixel correction process.

15. The reading apparatus according to claim 13, wherein
the plurality of correction modes include a plurality of learning correction modes each being a correction mode that corrects a color of a pixel of a background using the machine learning model, and
among learned model parameters of the machine learning model corresponding to the plurality of learning correction modes, the model execution unit obtains the learned model parameter corresponding to the learning correction mode selected by the selection unit.

16. The reading apparatus according to claim 15, wherein the plurality of learning correction modes include an image generation model and a classification model.

17. The reading apparatus according to claim 13, wherein the selection unit selects one of a plurality of correction modes based on document-related information being information related to the document.

18. The reading apparatus according to claim 13, further comprising a display control unit configured to perform control to display an image, wherein
the display control unit performs control to display an image corresponding to the selected correction mode.

19. A reading method comprising:
reading a document;
causing a machine learning model to execute a process using a read image of the document as an input, the machine learning model having been trained for correction of a background of a document surface by using a shape of the document surface; and
obtaining a corrected image subjected to a pixel correction process using a result of the process executed by the machine learning model, the pixel correction process being a process of correcting a color of a pixel of a background portion in the read image of the document.

20. A non-transitory computer readable storage medium storing a program for causing a computer to perform a reading method, the reading method comprising:
reading a document;
causing a machine learning model to execute a process using a read image of the document as an input, the machine learning model having been trained for correction of a background of a document surface by using a shape of the document surface; and
obtaining a corrected image subjected to a pixel correction process using a result of the process executed by the machine learning model, the pixel correction process being a process of correcting a color of a pixel of a background portion in the read image of the document.
